(19) United States
(12) Patent Application Publication
(10) Pub. No.: US 2024/0086857 A1
(43) Pub. Date: Mar. 14, 2024

(54) REGION MERGE IN RESOURCE SCHEDULING SYSTEM

(71) Applicant: SYMCOR INC., Mississauga (CA)

(72) Inventors: Ivan WELSH, Newmarket (CA); Allison POLIACIK, Oshawa (CA); Vicky KHANNA, Kitchener (CA); Greg BROTHERS, Bedford (CA); Marko BILIC, Missisauga (CA)

(21) Appl. No.: 18/367,217

(22) Filed: Sep. 12, 2023

Related U.S. Application Data
(60) Provisional application No. 63/405,762, filed on Sep. 12, 2022.

(51) Int. Cl. G06Q 10/1093

(52) U.S. Cl. CPC G06Q 10/1095

(57) ABSTRACT

A computer-implemented method for scheduling appointments including a provider servicing a consumer is disclosed. The method identifies geographic regions. The method schedules, for each of the regions, the appointments for a subset of the consumers subject to a first predefined constraint. Each of the appointments describes a provider associated with one region servicing a consumer of that region. The method determines a remaining subset of the consumers from each of the regions that cannot be scheduled without violating the constraint. The method combines the appointments from each of the regions to determine a partial schedule and schedules the appointments for the remaining subset subject to a second predefined constraint and the partial schedule. At least one of the appointments includes a provider associated with one region servicing a consumer of another region. The method determines a complete schedule based on the partial schedule and the appointments for the remaining subset.

### RELATED APPLICATIONS

This claims priority from U.S. provisional patent application No. 63/405,762, filed Sep. 12, 2022, the entire contents of which are incorporated herein by reference.

### FIELD

This disclosure relates to scheduling appointments, and more particularly to optimizing the scheduling of appointments between providers of a service and consumers of that service across multiple regions.

### BACKGROUND

Scheduling issues can arise in service-oriented industries where there is a high demand of consumers of a service compared to a low supply of providers of the service. For example, in the healthcare industry there may be many patients or other consumers of healthcare services compared to a low supply of healthcare providers. Scheduling appointments between these patients and healthcare providers may be difficult, given this supply limitation.

Moreover, this supply limitation may be exacerbated in situations where only a certain group of providers service a given geographical region, especially where that region contains a high density of consumers. As well, in some cases certain consumers may have specific preferences or servicing requirements, further restricting the number of providers that may service those consumers in a given geographical region. In the healthcare industry example, this situation may arise where certain patients require specialized care (e.g. paediatric, geriatric or palliative) that only a limited number of healthcare providers can provide. In many cases, healthcare providers must travel to the patient's place of residence, requiring a certain geographical proximity between patients and healthcare providers that may further limit the number of available and qualified healthcare professionals for scheduling.

Daily time-sensitive changes to a schedule, along with many hard and soft constraints that limit which consumers can be matched and scheduled appointments with which providers, result in reactive scheduling decisions. In addition, determining travel routes between those service providers and consumers increases the complexity of the scheduling problem. In many cases, poor scheduling decisions and unoptimized travel routes can mean that service providers spend more time travelling to consumers and less time servicing those consumers. In the case of the healthcare industry, this may result in a reduced quality of care for patients, since the limited number of healthcare professionals expend unnecessary time travelling between appointments instead of providing healthcare to patients in need.

Traditional scheduling solutions seek to optimize the schedule of appointments by using business rules, geographic information, and even artificial intelligence to help a human coordinator make a good scheduling decision for a single consumer of the service at a time (including when the service can be provided and by which provider). Although this can result in optimal point-in-time decision-making, over a long duration the overall schedule will still become fragmented as many one-off changes result in gaps, non-optimal travel routes, and inequitable distribution of service opportunities between service providers.

Accordingly, there is a need for an improved method for scheduling appointments.

### SUMMARY

In an embodiment, a computer-implemented method for scheduling appointments, wherein each of the appointments includes a provider servicing a consumer at a specific time and a specific location, including: identifying geographic regions, each of the regions containing consumers and associated with providers that service the region; scheduling, for each of the regions, the appointments for a subset of the consumers subject to a first predefined constraint, wherein each of the appointments for the subset of the consumers includes a provider associated with the region servicing a consumer of the region; determining a remaining subset of the consumers from each of the regions, wherein the remaining subset of the consumers cannot be scheduled without violating the first predefined constraint; combining the appointments from each of the regions to determine a partial schedule; scheduling the appointments for the remaining subset of the consumers subject to a second predefined constraint and the partial schedule, wherein at least one of the appointments for the remaining subset of consumers includes a provider associated with one of the regions servicing a consumer of another of the regions; and determining a complete schedule based on the partial schedule and the appointments for the remaining subset of the consumers.

In another embodiment, a computer-implemented method for optimizing a schedule of appointments, wherein each of the appointments includes a provider servicing a consumer at a specific time and a specific location, includes: receiving the schedule of the appointments, wherein the schedule is associated with a plurality of geographic regions and each of the appointments is associated with at least one of the regions; rescheduling, for each of the regions, a subset of the appointments, wherein the subset of the appointments are each associated with the region and rescheduled subject to a predefined constraint, the predefined constraint including a maximum quantity by which at least one of a specific time or a specific location of an appointment may be varied; determining, for each of the regions, that the appointments associated with the region are near-optimal; rescheduling a further subset of the appointments, wherein the further subset of the appointments is associated with the plurality of geographic regions and is rescheduled subject to the predefined constraint; and determining that the schedule is near-optimal.

Other aspects will be apparent from the detailed description.

### BRIEF DESCRIPTION OF THE DRAWINGS

In the figures, which illustrate example embodiments:

FIG. 1 depicts regions containing providers and consumers;

FIG. 2 is a diagram of a scheduling system for scheduling appointments;

FIG. 3 is a block diagram of a scheduling device in the scheduling system of FIG. 2;

FIGS. 4A-4C are block diagrams of a resources database in the scheduling system of FIG. 2;

FIGS. 5A-5C are block diagrams of a solution configuration in the scheduling system of FIG. 2;

FIGS. 6A-6C are tables of appointments scheduled for a subset of the consumers depicted in FIG. 1;

FIG. 7 is a partial schedule including the appointments of FIG. 6A-6C;

FIG. 8 is a remaining subset of the consumers depicted in FIG. 1;

FIG. 9 is a complete schedule determined using the scheduling system of FIG. 1;

FIG. 10 is an alternate embodiment of the complete schedule of FIG. 9;

FIG. 11 depict travel routes for a provider, based on the complete schedule of FIG. 9;

FIG. 12 is a flow chart illustrating a method for determining the complete schedule of FIG. 9;

FIGS. 13A-13C depict an alternate embodiment of the solution configuration in the scheduling system of FIG. 2;

FIG. 14 depict an alternate embodiment of a complete schedule of appointments determined using the scheduling system of FIG. 2;

FIG. 15 depicts an existing schedule of appointments and associated travel routes;

FIG. 16 depicts is a flow chart illustrating a method for optimizing the existing schedule of appointments of FIG. 15;

FIG. 17 depicts a predefined constraint, according to an embodiment; and

FIGS. 18A-18C depict tables and graphs recording iterations within the method of FIG. 16.

### DETAILED DESCRIPTION

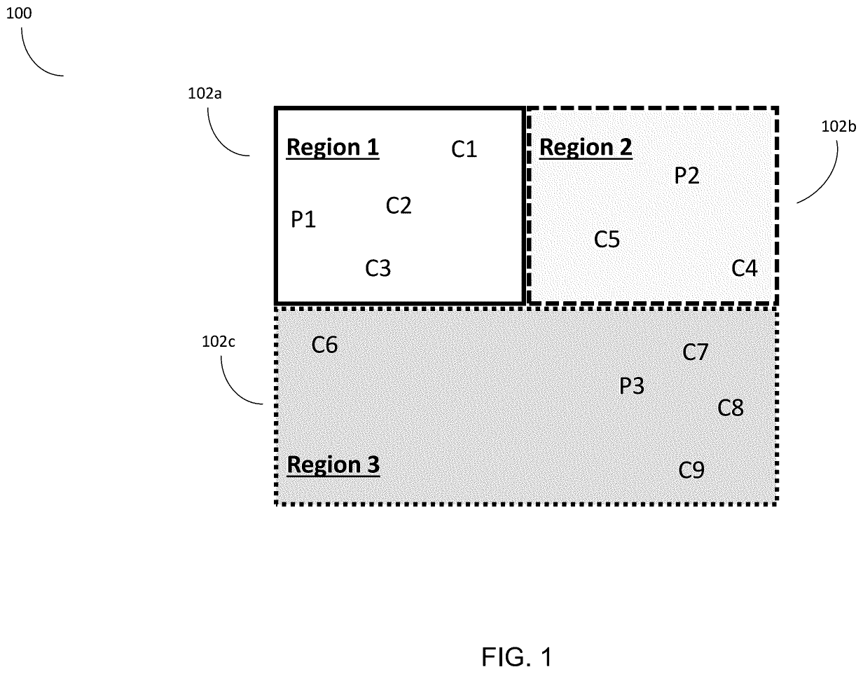

FIG. 1 depicts a scheduling sector 100. Sector 100 is a geographically delineated area containing exemplary geographic regions 102a, 102b, 102c (individually and collectively regions 102) and exemplary consumers C1-C9. Each of consumers C1-C9 is a consumer of a service located within one of regions 102. For example, consumer C1 may be located within, or originating within, region 102a, since the place of residence of consumer C1 is located within region 102a at specific geographic coordinates. Sector 100 also contains exemplary providers P1-P30. Each of providers P1-P3 is a provider of a service associated with one of regions 102. For example, provider P1 may provide service within region 102a, since provider P1 may reside in region 102a, work out of an office in region 102a or be generally assigned to region 102a for other reasons.

In the healthcare industry, for example, consumers C1-C9 may be healthcare patients or other consumers of healthcare service. Consumers C1-C9 may include patients seeking paediatric care, geriatric care, palliative care, physiotherapy, or other forms of healthcare. Similarly, providers P1-P3 may be healthcare professionals or other providers of healthcare service. Providers P1-P3 may include doctors, nurses, physiotherapists, and other specialized healthcare professionals.

Sector 100 is delineated to indicate consumers C1-C9 for which appointments should be scheduled. In an exemplary embodiment, an appointment is defined by one of providers P1-P3 providing service to one of consumers C1-C9 at a specific time and a specific location. For example, in the healthcare industry an appointment may be scheduled such that a healthcare provider P1 services a healthcare consumer C1 (i.e. a patient) at 9:00 am at the place of residence of consumer C1. It will be appreciated that in the healthcare industry, many appointments will be scheduled with patients at their homes. However, in some embodiments appointments will be scheduled at hospitals or other healthcare facilities (which may or may not be in the same region).

Sector 100 is delineated to indicate that appointments should be scheduled for all consumers C1-C9 located within sector 100, on a given day or within some other timeframe. However, as depicted in FIG. 1, in many instances there are fewer providers P1-P3 than consumers C1-C9. As well, in many instances certain providers P1-P3 are located too far away from consumers C1-C9 to be scheduled appointments with those consumers. For example, provider P1 may generally only service region 102a associated with provider P1 or consumers located within proximity of provider P1, for various preferential or scheduling reasons. Provider P1 may be located too far away from consumer C9 to service consumer C9 at their place of residence in region 102c. Provider P1 would spend too much time travelling to consumer C9 to provide service, where that travel time could instead be spent servicing other consumers located closer to provider P1. Related considerations, such as fuel consumption and the carbon footprint of provider P1 could prevent provider P1 from providing service to consumer C9. In the example of the healthcare industry, a healthcare professional or provider P1 would generally only provide healthcare to patients within the proximity of a hospital or healthcare centre, which may also serve as the location associated with provider P1.

Since provider P1 may generally only service consumers located within region 102a associated with provider P1, provider P1 may, for example, generally only service consumers C1-C3. However, reasons other than travel time may inhibit provider P1 from travelling to consumer C3, such as certain predefined scheduling constraints related to either provider P1 or consumer C3. For example, certain preferences or scheduling constraints may allow provider P1 to service consumer C2 but not consumer C3, even though both consumers C2, C3 reside in region 102a. Instead, consumer C3 will have to be scheduled an appointment with another provider, such as provider P2 or provider P3, depending on their preferences and scheduling constraints. In this example, however, providers P2-P3 are associated with a different region than consumer C3 is located within. As such, it may be difficult to schedule appointments such that all of consumers C1-C9 are serviced in a single day (or some other period of time) with only limited resources, such as providers P1-P3.

It is desirable to determine a method by which all consumers C1-C9 may be scheduled appointments with one of providers P1-P3 within a certain time frame, given travel times and related considerations, provider/consumer preferences and other scheduling constraints.

It will be appreciated that in further embodiments, sector 100 may contain fewer or more regions than regions 102a, 102b, 102c. Similarly, each of regions 102a, 102b, 102c may each be sub-divided into sub-regions. Sub-regions may also be similarly further divided.

As well, regions 102a, 102b, 102c may be any geographic shape and may not be contiguous. For example, in some embodiments region 102a may not share a boundary with any other regions in sector 100. In other embodiments, region 102a may contain two closed geographic areas that are not contiguous with one another.

It will also be appreciated that in further embodiments, sector 100 may contain fewer or more consumers than consumers C1-C9 and/or fewer or more providers than providers P1-P3. As well, consumers C1-C9 and P1-P3 may be located in different configurations than those depicted in FIG. 1.

In some further embodiments, consumers C1-C9 and/or providers P1-P3 may each have one or more locations associated with them. For example, provider P1 may be associated with region 102a and region 102c.

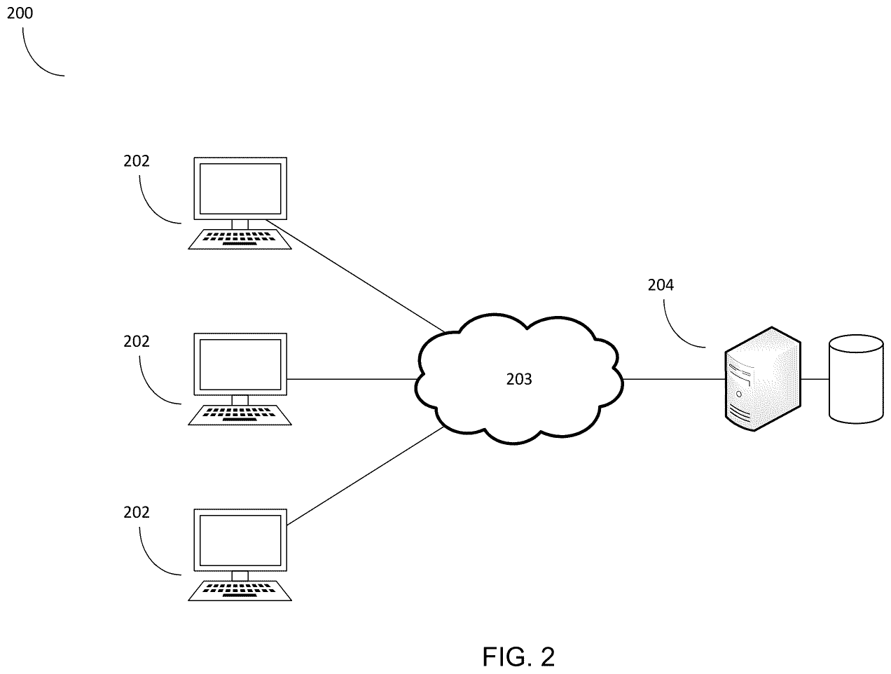

FIG. 2 depicts components of scheduling system 200 for scheduling appointments. Scheduling system 200 includes one or more client computing devices 202 and a scheduling device 204. Client devices 202 may each be operated by a user, a system administrator, a customer or some other client.

Client devices 202 may each be located at a different location from scheduling device 204. Components of scheduling device 204 may communicate with one another by way of one or more networks 203, which may comprise one or more local-area networks (LANs), wide-area networks (WANs), such as the Internet, or private WANs. Such networks may use any one or more of wired or wireless connection technologies, such as IEEE 802.21 (Wi-Fi), cellular, WiMax, or the like.

Additionally or alternatively, components of scheduling system 200 may be implemented fully or partially in software executed at shared hardware. For example, scheduling device 204 or portions thereof may be hosted at a common server or in a common distributed (e.g. cloud) computing environment.

In some embodiments, client devices 202 may include a server hosted by a customer, which may include various databases managed by the customer. Client devices 202 may connect to scheduling device 204 using a user interface, such as a website or an Application Programming Interface (API). In further embodiments, scheduling device 204 may connect to or access client devices 202 using a website, an API or some other programmatic means, such that scheduling device 204 may access various databases managed by the customer.

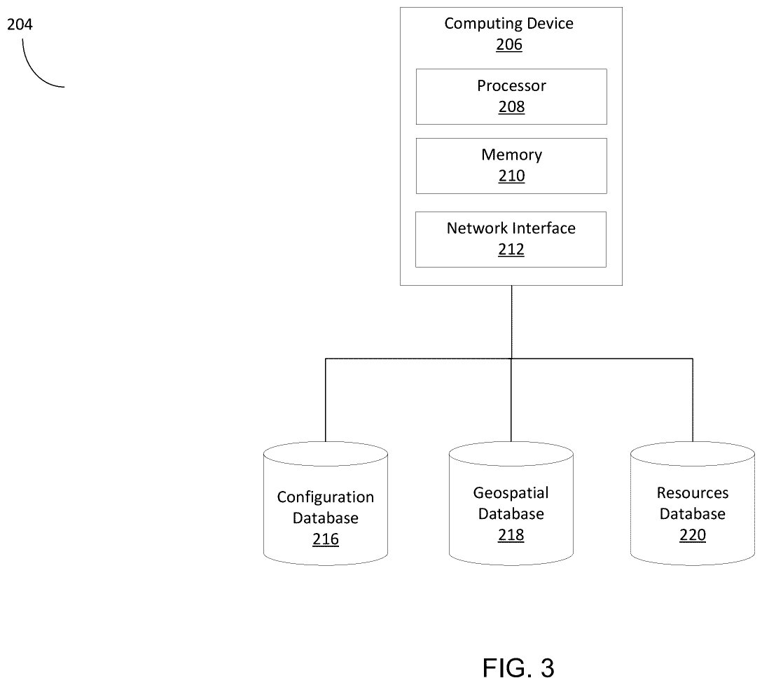

FIG. 3 depicts components of a scheduling device 204. Scheduling device 204 includes a computing device 206 and a resource database 220. Scheduling device 204 may also include a configuration database 216 and a geospatial database 218.

Computing device 206 includes a processor 208, a memory 210 and a network interface 212.

The processor 208 may be an intel or AMD x86-based processor, or an ARM-based processor, or any other suitable processor.

Memory 210 (e.g. RAM) includes a computer-readable storage space accessible by processor 208 for storage of working data and code. Memory 210 also includes persistent computer-readable storage containing instructions for execution by processor 208 and for storing data received by network interface 212. For example, memory 210 may contain instructions for scheduling appointments, which may be executed by processor 208. Memory 210 may include any one or more suitable memory types, such as flash memory, hard drives or the like.

Network interface 212 may be any suitable wired or wireless device connecting computing device 206 to one or more networks 203. Additionally, network interface may be suitable for communication with a data host, such as configuration database 216, geospatial database 218 and/or resource database 220. In some embodiments, network interface 212 may communication with the data host over one or more networks 203. Network interface 212 may be, for example, an Ethernet or IEEE 802.21 (Wi-Fi) network adapter.

Resources database 220 stores resources for use in scheduling appointments. Resources include information describing providers of a service and consumers of a service. As depicted in FIG. 1, exemplary providers may be providers P1-P3 and exemplary consumers may be consumers C1-C9. In further embodiments, resources may also include information describing transportation resources, such as vehicles, and other business resources. Computing device 206 may communicate with resources database 220 and retrieve resources from resources database 220 for scheduling appointments. In some embodiments, computing device 206 may also store resources in resources database 220, such as resources information received or retrieved from client devices 202.

In some embodiments, computing device 206 may be configured to format data received by network interface 212 into a standardized format. For example, computing device 206 may receive data from a client device 202. The received data may be formatted based on the environment of client device 202, such as for a customer database managed by a user of client device 202. Computing device 206 may format the received data from client device 202 to transform it into standardized format that can be used by computing device 206 for scheduling appointments. For example, computing device 206 may format data received from client device 202 into a standardized format for resources. Computing device 206 may further store this standardized data in resources database 220 for later use by computing device 206.

Configuration database 216 may store one or more solution configurations, which describe parameters for computing device 206 to use while scheduling appointments. For example, solution configuration may describe inputs, heuristics or characteristics of a scheduling algorithm executed by computing device 206. In some embodiments, computing device 206 may retrieve solution configuration from configuration database 216. Additionally, computing device 206 may also store a solution configuration or portions thereof in configuration database 216. For example, computing device 206 may receive instructions to revise a solution configuration, such as from client devices 202, and may store a revised solution configuration in configuration database 216.

In further embodiments, configuration database 216 may store additional configurations for computing device 206.

Geospatial database 218 may store geospatial data for use by computing device 206. For example, geospatial database 218 may also store information describing sector 100 and/or regions 102. Geospatial data may further include maps, roads, travel routes, landmarks, terrain and other information. Geospatial data may also include coordinates, such that the location of roads, landmarks and other information may be identified on maps stored in geospatial database 218. As well, geospatial database 218 may be configured to perform geospatial queries. Geospatial data may be formatted for use with geospatial querying, as well as with algorithms for determining and minimizing travel routes and travel time. For example, computing device 206 may retrieve geospatial data from geospatial database 218 and also send data to geospatial database 218 for geospatial querying. Computing device 206 may communicate with geospatial database 218 while performing algorithms for determining and minimizing travel routes and travel time.

Geospatial database may include various technologies for geospatial querying and other calculations. For example, tools like OpenStreetMap™ and graph databases may be used for calculating, storing and accessing distances between various map coordinates.

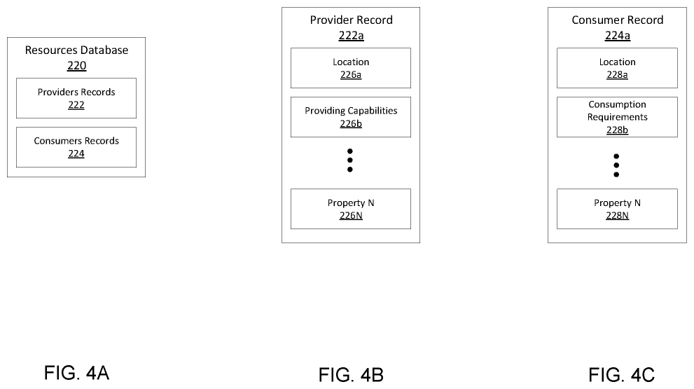

FIG. 4A depicts an embodiment of resources database 220. As described above, resources database 220 includes providers records 222 and consumers records 224. For example, providers records 222 may be information describing providers of a service. Similarly, consumers records 224 may be information describing consumers of the service. In an exemplary embodiment, providers records 222 may describe providers P1-P3 and consumers records 224 may describe consumers C1-C9.

Computing device 206 may retrieve providers records 222 and consumers records 224 from resources database 220 to schedule appointments for consumers C1-C9 with providers P1-P3. In an exemplary embodiment, an appointment may include one of providers P1-P3 servicing one of consumers C1-C9 at a specific time and a specific location. In other embodiments, an appointment may include one or more providers P1-P3 servicing one or more consumers C1-C9 at a specific time and a specific location.

In some embodiments, resources database 220 may include descriptions of other business resources, such as a vehicle for use by one or more of providers P1-P3. It will be appreciated that in those embodiments, an appointment may include one or more providers P1-P3 servicing one or more consumers C1-C9 at a specific time and a specific location, using one or more other specific business resources, such as a specific vehicle.

In some embodiments, computing device 206 may also record new or modified providers records 222 and consumers records 224 in resources database 220. For example, computing device 206 may receive providers records 222 and consumers records 224 from client devices 202, such as by accessing a customer database associated with one of client devices 202.

FIG. 4B depicts an embodiment of a provider record 222a, which may be stored in resources database 220. Provider record 222a may describe, for example, provider P1, and may include various properties 226 related to provider P1. For example, provider record 222a may include a location 226a, such as an address or a region of operation. For example, location 226a may describe the geographic coordinates associated with a base of operations of provider P1, which may also correspond to region 102a. Provider record 222a may also include providing capabilities 226b, which may describe the services that provider P1 is capable of providing or willing to provide.

Provider record 222a may further include one or more other properties, such as property 226N. In some embodiments, property 226N may indicate one or more predefined constraints associated with provider P1.

In the case of the healthcare industry, for example, property 226N may indicate one or more predefined constraints associated with a specific healthcare capability of provider P1, which may be a healthcare professional. Healthcare capabilities may include a specific type of treatment that the professional can provide, a qualification of the healthcare professional (e.g. doctor, nurse, physiotherapist, or a more specific qualification), the language capabilities of the professional, and other capabilities.

Similarly, FIG. 4C depicts an embodiment of a consumer record 224a. Consumer record 224a may describe, for example, consumer C1, and may include various properties 228 related to consumer C1. For example, consumer record 224a may include a location 228a, such as an address or a region in which consumer 224a can receive services. For example, location 228a may be the geographic coordinates of the place of residence of consumer C1, which may also be located within region 102a. Consumer record 224a may also include consumption requirements 228b, which may describe the services that consumer C1 is capable of receiving or needs to receive.

Consumer record 224a may further include one or more other properties, such as property 228N. In some embodiments, property 228N may indicate one or more predefined constraints associated with consumer C1.

In the case of the healthcare industry, for example, property 228N may indicate one or more predefined constraints associated with a specific healthcare need of consumer C1, which may be a healthcare patient. Healthcare needs may include a specific type of treatment required by the patient, any language requirements of the patient, a certain time of day of treatment, and other similar requirements.

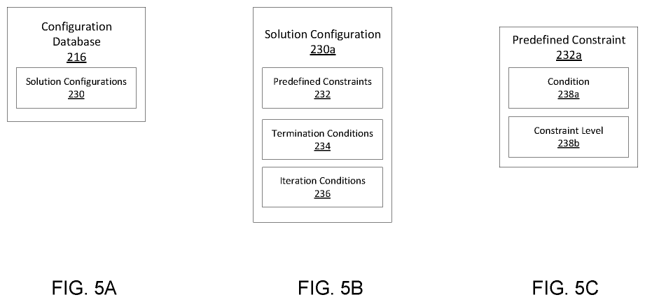

FIG. 5A depicts an embodiment of configuration database 216, which includes solution configuration 230. As described above, solution configurations 230 may each describe parameters for computing device 206 to use when scheduling appointments. Each of solution configurations 230 may be used to describe inputs, heuristics or characteristics of a scheduling algorithm executed by computing device 206, such that by using a different one of solution configurations 230 the performance of the scheduling algorithm may change.

FIG. 5B depicts an embodiment of a solution configuration 230a. Solution configuration 230a includes predefined constraints 232 for use by computing device 206 while executing scheduling algorithm to schedule appointments. Predefined constraints 232 may define rules that computing device 206 must follow while scheduling appointments, such that certain or all of predefined constraints 232 must not be violated by any scheduled appointment. In addition, predefined constraints 232 may define objectives that computing device 206 may try to achieve while scheduling appointments. For example, predefined constraints 232 may be used in a cost function, such that computing device 206 may attempt to minimize the cost function while scheduling appointments, i.e. computing device 206 may attempt to minimize the number of predefined constraints 232 that are violated for a completed schedule of appointments.

In some embodiments, a user or client may determine predefined constraints 232 through a user interface. For example, a user or client may access user interface through one of client devices 202. User interface may allow the user or client to indicate a desired modification to one or more predefined constraints 232, such as an indication of an addition, deletion or other amendment to one of predefined constraints 232. Scheduling device 204 may receive the indication over one or more networks 203, and may generate, remove or amend the indicated one or more predefined constraints. Modified predefined constraints 232 may, for example, be stored in configuration database 230.

Solution configuration 230a may also include termination conditions 234 and iteration conditions 236. Termination conditions 234 may describe when computing device 206 should terminate the scheduling algorithm for scheduling appointments. Iteration conditions 236 may describe how a scheduling algorithm determines how to advance or transition between states or possible solutions. For example, iteration conditions 236 may describe how to modify a first intermediate set of appointments to advance to a second intermediate set of appointments, such that the second intermediate set of appointments is closer to an optimized schedule of appointments than the first intermediate set of appointments.

FIG. 5C depicts an embodiment of a predefined constraint 232a. Predefined constraint 232a may include a condition 238a and a constraint level 238b. Condition 238a may describe a rule or objective that should be satisfied to avoid violating predefined constraint 232a. For example, condition 238a may describe a minimum distance or travel time between a provider scheduled to service a consumer in a scheduled appointment. Condition 238a may describe other rules, such as a range of times during with an appointment may be scheduled, a certain range of locations between a provider and consumer within which an appointment may be scheduled, and certain properties of providers records 222 and/or consumers records 224 that may be required for an appointment to be scheduled between corresponding providers P1-P3 and consumers C1-C9. In further embodiments, condition 238a may implement one or more union rules for a customer organization, such as a maximum number of hours that a provider may work in a single day. Condition 238a may also describe a preference for weekend appointments to be scheduled with junior providers instead of more senior providers. It will be appreciated that other conditions may be possible.

Constraint level 238b may describe whether condition 238a may be violated. For example, constraint level 238b may be one of a soft, medium or hard constraint level. The condition 238a of a predefined constraint 232a with a soft constraint level 238b may be more likely to be allowed to be violated while scheduling appointments than the condition of a predefined constraint with a medium or hard constraint level. In further embodiments, violating a condition 238a with a soft constraint level 238b should be avoided, but may be done if doing so allows a certain appointment to be scheduled. Violating a condition 232a with a medium constraint level 238b should also be avoided, but may be done so if doing so allows at least a certain quantity of appointments to be scheduled. A condition 238a with a hard constraint level 238b should never be violated. It will be appreciated that other constraint levels with different definitions may be possible.

Although condition 238a of predefined constraint 232a may be violated, predefined constraint 232a may not be deemed violated if constraint level 238b is soft or, in some cases, medium. In this way, conditions of predefined constraints with soft or, in some cases, medium constraint levels may be violated without violating predefined constraints while computing device 206 schedules appointments.

As discussed above, in some embodiments predefined constraints 232 may be used in a cost function. Computing device 206 may attempt to minimize the cost function while scheduling appointments. For example, computing device 206 may attempt to minimize the number of predefined constraints 232 whose conditions are violated for a completed schedule of appointments. As such, in these embodiments no predefined constraints 232 may be violated, because only predefined constraints 232 with soft (and potentially medium) constraint levels may have their conditions be violated. In further embodiments, computing device 206 may minimize a different cost function for each constraint level, i.e. a cost function for all predefined constraints 232 with a soft constraint level 238a, a second cost function for all predefined constraints 232 with a medium constraint level 238a, medium, and a third cost function for all predefined constraints 232 with a hard constraint level 238a.

In some embodiments, predefined constraints 232 may be associated with a specific resource, such as provider 222a or consumer 224a. For example, predefined constraint 232a may specify that consumer C1 should only be scheduled appointments with a provider located within ten kilometres of consumer C1. As such, location 226a associated with provider record 222a for provider P1 should be within ten kilometres of location 228a associated with consumer record 224a for consumer C1. In such embodiments, provider record 222a and/or consumer record 224a may include additional properties specifying one or more of predefined constraints 232.

In other embodiments, predefined constraints 232 may generally refer to specific properties described by resources in resources database 220. For example, a predefined constraint 232a may refer to a specific type of property, such as property 226N described in provider record 222a or property 228N in consumer record 224a. In particular, condition 238a may specify certain scheduling constraints that must be followed related to property 226N, 228N.

In further embodiments, predefined constraints 232 may also include properties specifying one or more resources described in resources database 220 that are associated with each of predefined constraints 232. For example, predefined constraint 232a may specifically describe provider P1 by referring to provider record 222a or specifically describe consumer C1 by referring to consumer record 224a. In the example of the healthcare industry, predefined constraint 232a may specifically describe a healthcare specialty or qualification of provider P1, which may be a healthcare professional, by referring to provider record 222a. Similarly, predefined constraint 232a may specifically describe a healthcare need or language requirement of consumer C1, which may be a healthcare patient, by referring to consumer record 232a.

In other alternate embodiments, predefined constraints 232 may specify suggested or pre-existing appointments, such as an appointment between a provider and consumer pre-selected by a client or user. Such predefined constraints 232 may represent a pre-existing schedule created by client or user, which should be used as a starting point for scheduling further or more optimal appointments.

Generally, appointments may be scheduled according to a variety of different methods. For example, computing device 206 may execute a variety of scheduling algorithms to determine an optimized schedule. As discussed above, solution configurations 230 in configuration database 216 may specify various parameters of the scheduling algorithm, such as predefined constraints 232, termination conditions 234 and iteration conditions 236.

Scheduling algorithm may incorporate various technologies. For example, scheduling algorithm may execute tools like Gurobi™, LocalSolver™, OptaPlanner™, IBM ILOG CP Optimizer™ and Google OR-Tools™ to solve “Travelling Salesman” problems with predefined hard and soft constraints.

It will be appreciated that scheduling algorithm may attempt to solve a many-to-many problem. In particular, a many-to-many relationship exists between consumers C1-C9 and providers P1-P3, subjected to one or more pre-defined constraints. Scheduling algorithm may attempt to schedule appointments for all consumers C1-C9, and in an exemplary embodiment each consumer may be scheduled an appointment with one or more of providers P1-P3. Due to one or more-predefined constraints, however, appointments may not be scheduled between one or more of consumers C1-C9 and one or more of providers P1-P3.

As described above, a provider may generally only service consumers located within the region associated with that provider. For example, provider P1 may generally only service consumers C1-C3 within region 102a. However, provider record 222a for provider P1 may indicate predefined constraint 232a for provider P1, which prevents provider P1 from being scheduled an appointment with consumer C3. Alternatively, another predefined constraint indicated for consumer C3 may similarly prevent provider P1 from being scheduled an appointment with consumer C3. It will be appreciated that in other embodiments more than one provider may service region 102a.

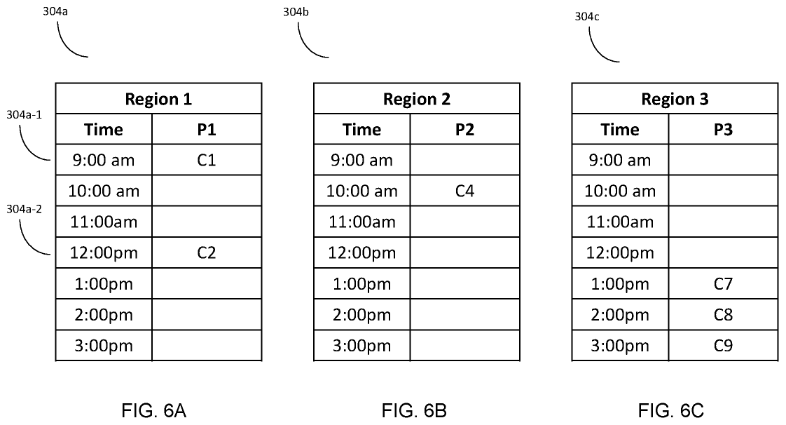

FIGS. 6A-6C depict appointments 304a, 304b, 304c (individually and collectively appointments 304). FIG. 6A depicts appointments 304a scheduled for a subset of consumers in region 102a. Subject to predefined constraint 232a, appointment 304a-1 was scheduled for consumer C1 with provider P1 and appointment 304a-2 was scheduled for consumer C2 with provider P1. In particular, scheduled appointments 304a for consumers C1-C2 include provider P1 associated with region 102a servicing each of consumers C1-C2 of region 102a. However, a remaining subset of consumers in region 102a cannot be scheduled an appointment without violating predefined constraint 232a. That is, due to predefined constraint 232a associated with provider P1 (or some other predefined constraint associated with consumer C3), consumer C3 has not been scheduled an appointment with provider P1. In the healthcare industry, for example, consumer C3 may be a patient with certain healthcare needs, and although provider P1 may be a healthcare professional, provider P1 may not have the necessary qualification to service those healthcare needs, i.e. consumer C1 may require physiotherapy but provider P1 may not be a physiotherapist. As such, there is no appointment for consumer C3 in appointments 304a.

FIGS. 6B-6C similarly depicts appointments scheduled for a subset of consumers in regions 102b and 102c, respectively, subject to one or more predefined constraints 232b and 232c. In particular, appointments 304b and appointments 304c were scheduled for consumers in regions 102b and 102c, respectively. However, due to predefined constraint 232b associated with either provider P2 or consumer C5, an appointment could not be scheduled for consumer C5 with any provider associated with region 102b. Similarly, due to predefined constraint 232c, an appointment could not be scheduled for consumer C6 with any provider associated with region 102c.

It will be appreciated that predefined constraint 232a may be the same as or different than predefined constraints 232b used to schedule appointments for consumers in region 102b, and may also be the same as or different than predefined constraint 232c used to schedule appointments for consumers in region 102c. For example, in the case of the healthcare industry, predefined constraint 232a could refer to a physiotherapy requirement or qualification, while predefined constraint 232b could refer to specific language requirements of either provider P2 or consumer C5. Alternatively, both predefined constraint 232a and 232b could refer to a physiotherapy requirement or qualification.

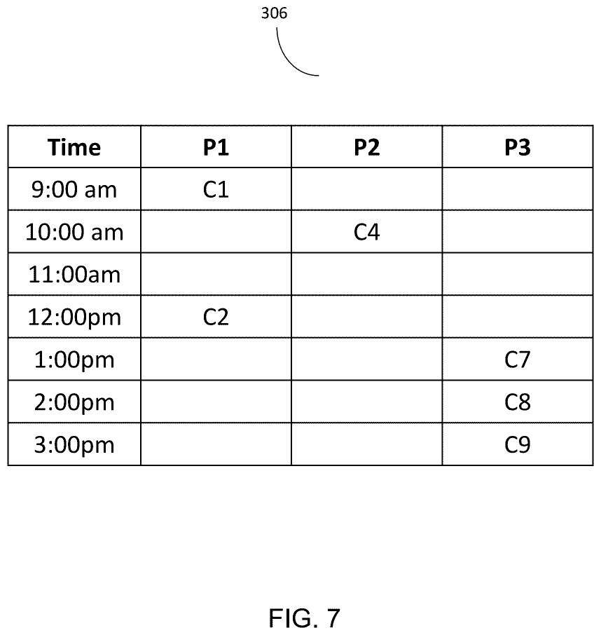

FIG. 7 depicts a partial schedule 306, combining appointments 304a, 304b, 304c for regions 102a, 102b, 102c, respectively. Partial schedule 306 combines appointments scheduled for the subsets of consumers from regions 102a, 102b, 102c, subject to predefined constraints 232a, 232b, 232c. Generally, combining appointments 304 includes generating partial schedule 306 such that partial schedule 306 includes each of appointments 304.

However, as already discussed, a remaining subset of consumers from each of regions 102a, 102b, 102c could not be scheduled appointments without violating predefined constraints 232a, 232b, 232c, respectively. For example, consumers C3 in region 102a could not be scheduled an appointment with any provider in region 102a without violating predefined constraint 232a. With reference to consumers C1-C9 depicted in FIG. 1 and partial schedule 306 depicted in FIG. 7, remaining subset of consumer includes consumers C3, C5, C6.

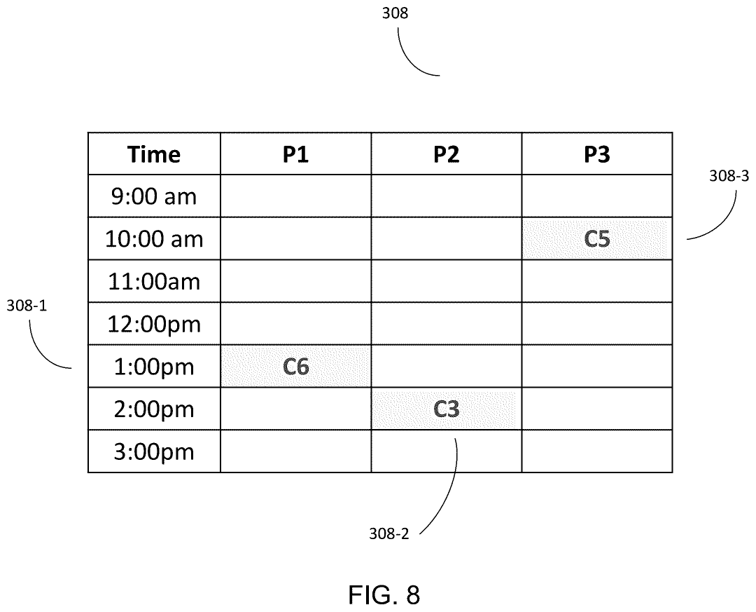

Although each of consumers C3, C5, C6 in remaining subset of consumers cannot be scheduled an appointment with a provider associated with the region in which that consumer is located, it is desirable to schedule appointments for all consumers C1-C9. As such, although a provider may generally only service consumers located within the region that the provider is associated with, it may be possible for the provider to service consumers located in a different region but within proximity of the location of the provider. For example, although provider P1 is located in region 102a, it may be possible for provider P1 to service consumer C6 located in region 102c due to the proximity of consumer C6 to provider P1. In the situation where consumer C6 could not be scheduled an appointment with any provider within region 102c without violating a predefined constraint (i.e. with provider P3), an appointment may be scheduled between provider P1 and consumer C6 subject to predefined constraint 332a and partial schedule 306. Importantly, the appointment scheduled between provider P1 and consumer C6 may not violate partial schedule 306, which includes appointments 304a-1 and 304a-2 between provider P1 and consumers C1-C2, respectively. For example, FIG. 8 depicts scheduled appointments 308 for the remaining subset of consumers, including an appointment 308-1 scheduled between provider P1 and consumer C6 at 1:00 pm at the place of residence of consumer C6. Appointment 308-1 does not violate either predefined constraint 332a or partial schedule 306. Similarly, appointments 308-2 and 308-3 were scheduled between providers P2 and P3 and consumers C3 and C5, respectively, without violating predefined constraints 232b, 232c or partial schedule 306.

In another embodiment, appointment 308-1 may be scheduled between provider P1 and consumer C6 subject to partial schedule 306 and one or more other predefined constraints, which may be the same as or different than predefined constraint 332a.

Other reasons, in addition to the proximity between a provider in one region and a consumer in another region, may justify scheduling an appointment between that provider and consumer. For example, provider P1 may own a fuel-efficient vehicle or may have a rare set of skills. In the example of the healthcare industry, provider P1 may be a specially trained healthcare worker. As such, an appointment may be scheduled between provider P1 and consumer C6 subject to predefined constraint 332a and partial schedule 306, even if provider P1 and consumer C6 are located quite far from one another.

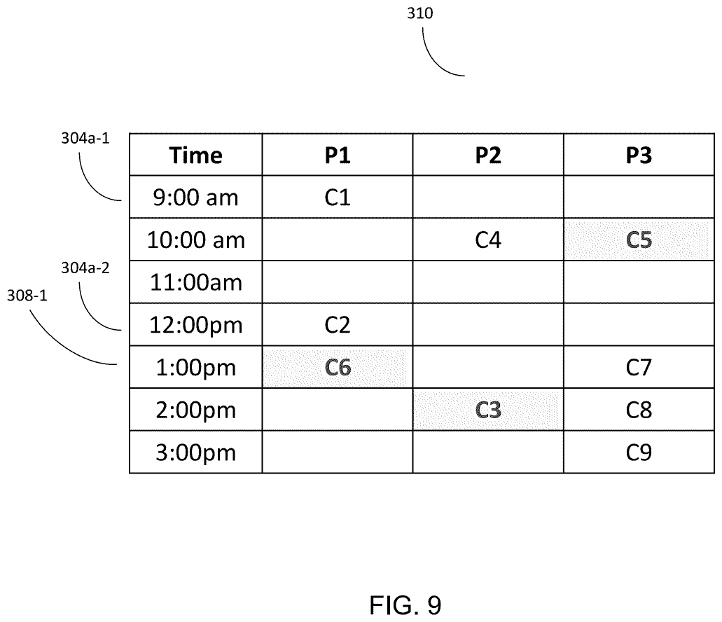

FIG. 9 depicts a complete schedule 310, combining appointments 304a, 304b, 304c for regions 102a, 102b, 102c, respectively, and appointments 308 for remaining subset of consumers. Complete schedule 310 includes appointments 304 and 308 for each of consumers C1-C9 without violating any predefined constraints.

In a further embodiment, appointment 308-1 scheduled between provider P1 and consumer C6 may violate partial schedule 306 in certain situations, during which one or more appointments in appointments 304 may need to be rescheduled subject to at least one predefined constraint. This at least one predefined constraint may also be the same as or different than predefined constraints 232a, 232b, 232c. After rescheduling one or more appointments in appointments 304, partial schedule 306 may need to be updated.

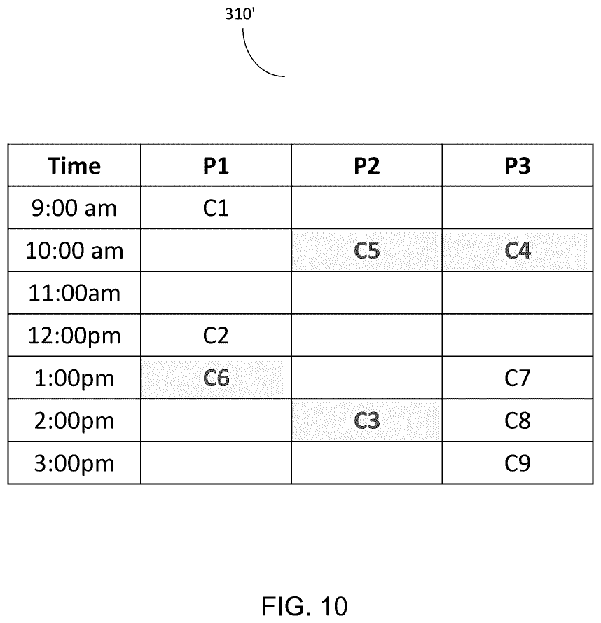

For example, FIG. 10 depicts an alternate complete schedule 310′, in which the appointment between provider P2 and consumer C4 in partial schedule 306 was rescheduled. Without modifying partial schedule 306, it may not have been possible to schedule appointments for remaining subset of consumers C3, C4, C6 without violating one or more predefined constraints and partial schedule 306. Consequently, the appointment for consumer C4 was rescheduled from an appointment with provider P2 to be an appointment with provider P3, subject to predefined constraint 232c associated with provider P3. It will be appreciated that the appointment for consumer C4 is rescheduled from provider P2 to provider P3 even though provider P3 is associated with a different region than the one in which consumer C4 is located. It will also be appreciated that in some embodiments, rescheduling the appointment may mean that the specific time and/or the specific location of the appointment for consumer C4 may be modified.

Since partial schedule 306 was updated with this rescheduled appointment for consumer C6, an appointment was scheduled for consumer C5 with provider P2 at 10:00 am and at the location at which consumer C5 resides. As a result, alternate complete schedule 310′ includes appointments for all of consumers C1-C9.

As describe above, in an exemplary embodiment partial schedule 306 may be modified to prevent one or more appointments 308 for remaining subset of consumers C3, C4, C6 from violating one or more predefined constraints 232a, 232b, 232c, respectively. In further embodiments, a user or a client may specify a list of appointments 304 in partial schedule 306 that should not be modified. For example, a user or client may view partial schedule 306 through a user interface, which may be accessible through client devices 202 or some other means. Partial schedule 306 may be shared with client devices 202 by scheduling device 204 by way of one or more networks 203. Through the user interface, the user or client may select or input one or more of appointments 304 that should not be modified. In the example of the healthcare industry, the user or client may be a hospital or healthcare facility. The user interface may also display a score or some other metric for each of scheduled appointments 304 in partial schedule 306, which may assist user or client to determine which of appointments 304 should not be modified. For example, a score associated with each of scheduled appointments 304 may be determined by one or more cost functions used by the scheduling algorithm. A cost function may, for example, be one of a time travelled cost function, a distance travelled cost function, a fuel consumption cost function, a carbon footprint cost function, or some other cost function. Additionally, a single cost function may combine multiple cost functions.

In alternate embodiments, partial schedule 306 may not be modified, even when doing so may prevent one or more appointments 308 for remaining subset of consumers C3, C4, C6 from violating one or more predefined constraints 232a, 232b, 232c, respectively.

In further alternate embodiments, the user or client may select or input a maximum quantity by which one or more of appointments 304 may be modified, such that the time or location of an appointment may not be varied more than maximum quantity. User or client may input maximum quantity through the user interface. For example, user or client may specify that appointments 304 in partial schedule 306 should not be modified by more than two hours or take place at a location more than five kilometres away. It will be appreciated that other thresholds may also be possible, such that partial schedule 306 should not be modified more than one hour, three hours, five hours, etc. The maximum quantity by which one or more of appointments 304 may be modified may be implemented as a predefined constraint, such as with a soft, medium or hard constraint level.

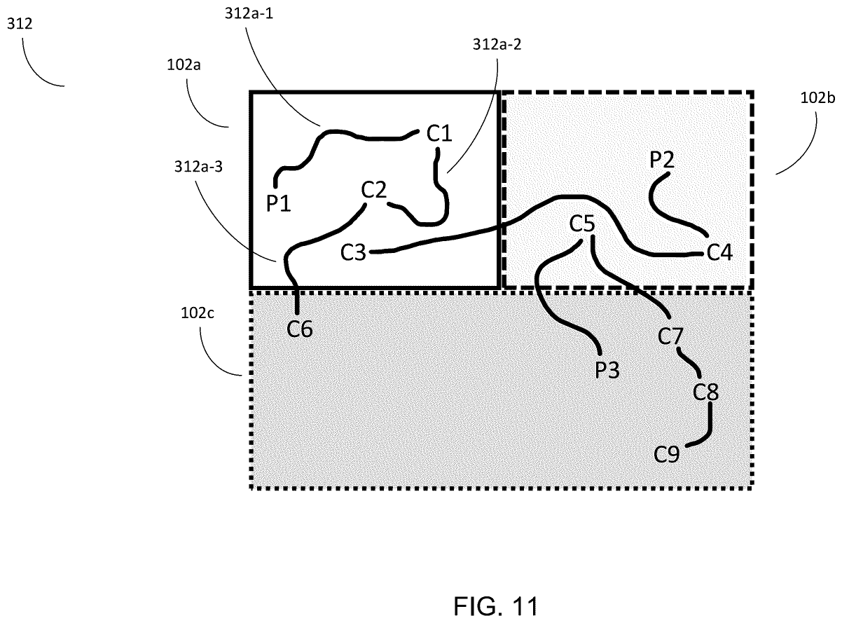

In some embodiments, complete schedule 310 may also include travel routes for providers P1-P3 to follow while travelling to appointments with consumers C1-C9. For example, FIG. 11 depicts travel routes 312 for complete schedule 310. Each of travel routes 312 may be associated with one of appointments 304 and 308. Each of travel routes 312 may include one or more directions for a provider to travel from a starting location to the specific location associated with the appointment.

Travel routes 312 may be determined from complete schedule 310 using a variety of methods. For example, travel routes 312 may be determined and updated as each of appointments 304 and 308 for each of consumers C1-C9 is scheduled. Accordingly, travel times, distances and fuel consumption associated with travel routes 312 may also be considered during scheduling of appointments, such as when evaluating whether one or more predefined constraints will be violated by an appointment. Travel routes 312 may instead be determined first for appointments 304 in partial schedule 306 and then for the remaining appointments in complete schedule 310. Similarly, travel routes 312 may instead only be determined once for all appointments 304 and 308 scheduled in complete schedule 310.

As discussed above, travel routes 312 may be determined based on complete schedule 310. For example, complete schedule 310 depicted in FIG. 9 includes appointments scheduled for consumers C1, C2, C6 with provider P1. In an exemplary embodiment, travel routes 312 includes travel routes 312a-1, 312a-2, 312a-3, respectively, for appointments scheduled for consumers C1, C2, C6 with provider P1. In particular, travel route 312a-1 may designate the route that provider P1 may need to traverse, such as by vehicle or public transit, to travel from the specific location associated with provider P1 to the place of residence of consumer C1. According to complete schedule 310, provider P1 may need to arrive at this location by 9:00 am to service consumer C1 during scheduled appointment 304a-1.

Similarly, travel route 312a-2 may designate the route that provider P1 may need to traverse to travel from the location associated with consumer C1 in the previous appointment 304a-1 to arrive at the place of residence of consumer C2. According to complete schedule 310, provider P1 may need to arrive at this location by 12:00 pm to service consumer C2 during scheduled appointment 304a-2.

Finally, travel route 312a-3 may designate the route that provider P1 may need to traverse to travel from the location associated with consumer C2 in in the previous appointment 304a-2 to arrive at the place of residence of consumer C6. According to complete schedule 310, provider P1 may need to arrive at this location by 1:00 pm to service consumer C6 during scheduled appointment 308-1. It will be appreciated that in this example provider P1 must travel from region 102a to region 102c while traversing travel route 312a-3.

Travel routes 312 may also include other travel paths for appointments scheduled for consumers C3-05 and C7-C9.

Although not depicted in FIG. 11, travel routes 312 may further include travel routes to locations not associated with a scheduled appointment. For example, in complete schedule 310 the length of time between consecutive appointments 304-1 and 304a-2 may be a few hours, such that provider P1 may wish to travel to another location to rest or work in between travelling to the location associated with consumer C2. As such, travel routes 312 may include these additional travel routes. In a further example, travel routes 312 may also include travel routes from the home of provider P1 to the first appointment, and from the last appointment to the home of provider P1. Various methods may be used to determine these travel routes 312, including one or more predefined constraints associated with provider record 222a associated with provider P1.

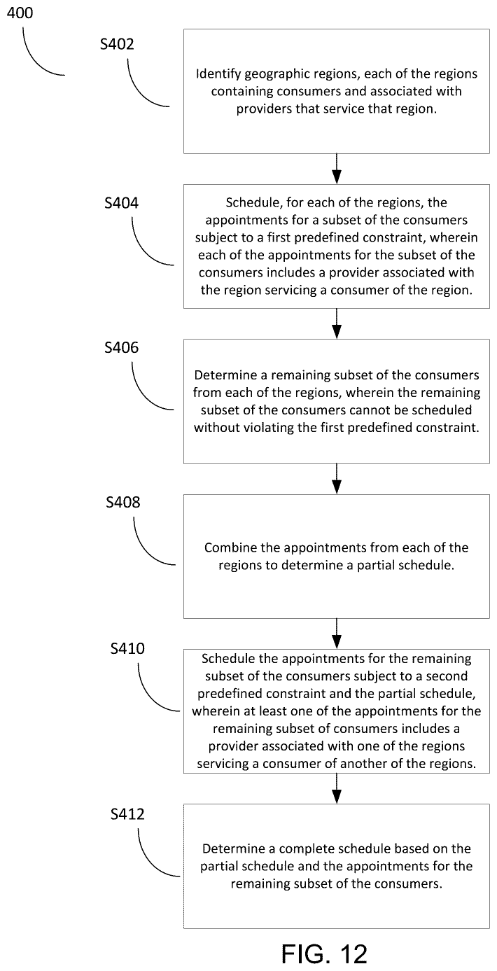

FIG. 12 depicts a method 400 for scheduling appointments, performed by scheduling device 204. As discussed above, each of appointments includes a provider servicing a consumer at a specific time and a specific location.

In some embodiments, the specific location of the appointment is a location associated with the consumer, such as the place of residence or home of the consumer. In other embodiments, the specific location of the appointment is some other location associated with either the consumer or the provider with which the appointment is scheduled with, such as a facility or other centre. In the example of the healthcare industry, appointments for healthcare patients may be scheduled with healthcare professionals at the home of the patient, a local hospital, or some other hospital or facility with the necessary resources for care to be provided.

At block S402, scheduling device 204 identifies geographic regions 102 within sector 100, each of regions 102 containing one or more of consumers C1-C9 and associated with one or more of providers P1-P3 that service that region. For example, region 102a contains consumers C1-C3 and is associated with provider P1 that services region 102.

In some embodiments, regions 102 may be identified using geospatial database 218. For example, geospatial database 218 may store sector 100 and regions 102, or information describing regions 102 may be retrieved from one or more client devices 202 and used to query geospatial database 218 to identify regions 102. Information describing regions 102 may include a unique label or identifier for each region, such as an area code, postal code, address or other identifier that may be correlated with map data. Unique label or identifier may be used to query geospatial database 218 to retrieve each of regions 102. Identifying regions 102 may thus include retrieving a collection of coordinates identifying a geographic boundary for each of regions 102. In further embodiments, geographic coordinates representing the geographic boundaries for each of regions 102 may be defined by geospatial database 218. In some embodiments, the geographic boundary for each of regions 102 may be retrieved from one or more client devices 202 instead of geospatial database 218.

Alternatively, identifying regions 102 may only include retrieving a unique label or identifier for each of regions 102, instead of retrieving a collection of coordinates identifying a geographic boundary for each of regions 102. Unique label or identifier for each of regions 102 may distinguish each region from one another. For example, unique label or identifier may be one of “Region 1”, “Northern Region”, an area code, a postal code, etc. Unique label or identifier may be retrieved from one or more client devices 202 and/or geospatial database 218.

Identifying regions 102 may also include identifying one or more consumers C1-C9 and one or more providers P1-P3 associated with each of regions 102. Providers P1-P3 and consumers C1-C9 may be identified from resources database 220 by retrieving providers records 222 and consumers records 224 describing providers P1-P3 and consumers C1-C9, respectively. In some embodiments, information describing regions 102 may also be stored in resources database 220, such as in a property of provider records 222 or consumer records 224. Information describing regions 102 may be used to retrieve regions 102 from geospatial database 218.

In some embodiments, one or both of a unique label/identifier or geographic coordinates associated with each of regions 102 may be retrieved from one or more client devices 102 and/or geospatial database 218, as described above. Unique label/identifier or geographic coordinates associated with each of regions 102 may be used to identify one or more consumers C1-C9 and one or more providers P1-P3 associated with each of regions 102. For example, unique label for region 102a may be the postal code “XOE 0R2”. Consumers records for 224 for consumers C1-C3 may all include the same postal code (“XOE 0R2”), such that consumers C1-C3 may be identified as being associated with region 102a. Similarly, providers record 222a for provider P1 may also include the same postal code (“XOE 0R2”), such that provider P1 may also be identified as being associated with region 102a. Resources database 220 and/or geospatial database 218 may also be used to identify one or more consumers C1-C9 and one or more providers P1-P3 associated with each of regions 102.

It will be appreciated that in some embodiments identifying regions 102 may include defining geographic boundaries associated with regions 102, such as by using geospatial database 218. In other embodiments, regions 102 may already be pre-identified and must be retrieved from a database. However, in further embodiments identifying regions 102 may not require identifying any geographic coordinates or geographic boundaries associated with regions 102. As such, in some embodiments, regions 102 may not include any geographic data at all, and may instead be used to identify the subsets of consumers C1-C9 that can be serviced by the subsets of providers P1-P3, each subset of consumers and corresponding subset providers indicating a region.

At block S404, scheduling device 204 schedules, for each of the regions 102, appointments 304 for a subset of the consumers subject to a first predefined constraint. For each of regions 102, each of the appointments 304 for the subset of the consumers includes a provider associated with the region servicing a consumer of the region. For example, scheduling device 204 may schedule, for region 102a, appointments 304a for a subset of the consumers C1-C2 subject to a first predefined constraint, which may be predefined constraint 232a. For region 102a, each of the appointments in appointments 304a-1 and 304a-2 for the subset of the consumers C1, C2 includes provider P1 associated with region 102a servicing one of consumers C1, C2 of region 102a.

Similarly, scheduling device 204 may schedule, for region 102b, appointments 304b for a subset of the consumers C4 subject to a first predefined constraint, which may be predefined constraint 232b. Scheduling device 204 may also schedule, for region 102c, appointments 304c for a subset of the consumers C7-C9 subject to a first predefined constraint, which may be predefined constraint 232c.

Generally, scheduling device 204 may attempt to schedule appointments for each of consumers C1-C9 in each of regions 102. Subject to first predefined constraint, which may be a plurality of predefined constraints in some embodiments, for each region 102 scheduling device 204 may attempt to schedule appointments for each of consumers C1-C9 associated with that region only with those providers P1-P3 that are also associated with that region. It will be appreciated in many embodiments there will be more than one provider P1-P3 associated with a single region. As such, scheduling device 204 may thus attempt to solve a many-to-many problem, since it is possible that a each of consumers C1-C9 in a region may be scheduled an appointment with more than one provider in that same region.

Scheduling device 204 may schedule appointments 304 using a variety of scheduling methods or algorithms. As well, scheduling device 204 may schedule appointments 304 such that appointments 304 are scheduled in an optimized manner. In particular, appointments 304a for region 102a may be scheduled in a manner that minimizes the travel time or distance that provider P1 must spend or traverse while travelling between appointments. Alternatively or in addition, appointments 304a may be scheduled in a manner that minimizes the amount of gas provider P1 must expend while travelling or the carbon footprint of provider P1. As well, appointments 304a may be scheduled in a manner that minimizes the quantity of predefined constraints 232 with soft or medium constraint levels whose conditions must be violated by the scheduled appointments. In addition, the above metrics may be represented by a cost function in the scheduling algorithm, which may be minimized or maximized while scheduling appointments 304a. Other metrics than those listed here may also be represented by a cost function in the scheduling algorithm. In some embodiments, scheduling device 204 may attempt to minimize or maximize multiple metrics while scheduling appointments 304a for region 102a.

Similarly, scheduling device 204 may attempt to minimize or maximize one or more other metrics while scheduling appointments 304b for region 102b, appointments 304c for region 102c, or appointments for one or more other regions.

In further embodiments, scheduling device 204 may attempt to minimize or maximize one or more universal metrics while scheduling appointments 304, such that appointments 304 are generally optimized.

It will be appreciated that a variety of scheduling algorithms may be used, including a variety of optimization algorithms. Parameters of the scheduling algorithm may be determined using one of solution configurations 230, which may be retrieved by computing device 206 from configuration database 216.

As discussed above, scheduling device 204 attempts at block S404 to schedule appointments for each of consumers C1-C9 in each of regions 102 with a provider in the same region, subject to first predefined constraint. However, one or more of consumers C1-C9 may not be successfully scheduled an appointment due to first predefined constraint or other scheduling limitations/conflicts, e.g. all providers in that region are already scheduled or are unavailable.

At block S406, scheduling device 204 determines a remaining subset of the consumers from each of regions 102. In particular, the remaining subset of the consumers includes consumers that cannot be scheduled without violating the first predefined constraint. For example, scheduling device 204 determines remaining subset of consumers C3, C5, C5 from each of regions 102a, 102b, 102c. Consumer C3 cannot be scheduled an appointment with provider P1 without violating predefined constraint 232a. Similarly, consumer C5 cannot be scheduled an appointment with provider P2 without violating predefined constraint 232b, and consumer C6 cannot be scheduled an appointment with provider P3 without violating predefined constraint 232c.

At block S408, scheduling device 204 combines appointments 304 from each of regions 102 to determine partial schedule 306. For example, scheduling device 204 combines appointments 304a from region 102a, including appointments 304a-1 and 304a-2, with appointments 304b from region 102b with appointments 304c from region 102c to determine partial schedule 306. As described herein, block S408 may further include specifying or “pinning” one or more appointments, from partial schedule 306, that are not to be modified in subsequent scheduling of the appointments for the remaining subset of the consumers C3, C5, C5.

In some embodiments, combining appointments 304 from each of regions 102 to determine partial schedule 306 may include additional processing blocks, such as generating travel routes associated with appointments 304, generating a visual appealing or graphical partial schedule 306 or indicating potential deficiencies in partial schedule 306 after appointments 304 from each of regions 102 have been assessed together. For example, scheduling device 204 may determine a score for partial schedule 306 after combining appointments 304, the score indicating how well partial schedule 306 satisfies certain metrics or minimizes/maximizes certain cost functions or constraints.

At block S410, scheduling device 204 schedules appointments 308 for the remaining subset of the consumers C3, C5, C6 subject to a second predefined constraint and partial schedule 306. At least one of appointments 308 for the remaining subset of consumers C3, C5, C6 includes a provider associated with one of regions 102 servicing a consumer of another of regions 102. For example, scheduling device 204 schedules appointment 308-1 for consumer C6 from the remaining subset of consumers C3, C5, C6 subject to a second predefined constraint 232a and partial schedule 306. Appointment 308-1 includes provider P1 associated with region 102a servicing consumer C6 associated with another of regions 102, namely region 102b.

Similarly, scheduling device 204 schedules appointment 308-2 for consumer C3 from the remaining subset of consumers C3, C5, C6 subject to a second predefined constraint 232b and partial schedule 306. Scheduling device 204 also schedules appointment 308-3 for consumer C5 from the remaining subset of consumers C3, C5, C6 subject to a second predefined constraint 232c and partial schedule 306.

In some embodiments, second predefined constraint may be the same as first predefined constraint. For example, when scheduling device 204 schedules appointment 308-1 for consumer C6 from the remaining subset of consumers C3, C5, C6 subject to a second predefined constraint, second predefined constraint may be the same as first predefined constraint, namely predefined constraint 232b. Alternatively, when scheduling device 204 schedules appointment 308-1 for consumer C6 from the remaining subset of consumers C3, C5, C6 subject to a second predefined constraint, second predefined constraint may be different from first predefined constraint, such as predefined constraint 232a or some other predefined constraint. For example, in the example where first predefined constraint and second predefined constraint are different, first predefined constraint could refer a necessary qualification for a provider, while second predefined constraint could refer a scheduling limitation for a provider, i.e. that the provider cannot be scheduled after 3 pm. Alternatively, in the example where first predefined constraint and second predefined constraint are the same, both first predefined constraint and second predefined constraint could refer to the same scheduling requirement, i.e. that the provider cannot be scheduled after 3 pm.

At block S412, scheduling device 204 determines complete schedule 310 based on the partial schedule 306 and appointments 308 for the remaining subset of consumers C3, C5, C6.

In one embodiment, block S412 may include combining appointments 308 for the remaining subset of consumers C3, C5, C6 with partial schedule 306 to determine complete schedule 310. As discussed above, complete schedule 310 includes appointments 304 and 308 for each of consumers C1-C9 without violating any predefined constraints.

Other methods of determining complete schedule 310 based the partial schedule 306 and appointments 308 for the remaining subset of consumers C3, C5, C6 may be possible. For example, determining complete schedule 310 may include improving partial schedule 306, such as rescheduling one or more of appointments 304 to reduce at least one of a travel time, a travel distance, a fuel consumption and a carbon footprint for one or more providers P1-P3.

In some embodiments, determining complete schedule 310 may also include determining travel routes 312. Each of travel routes 312 may be associated with one of appointments 304 and 308, and may include one or more directions for a provider to travel from a starting location to the specific location associated with the appointment. For example, travel route 312a-2 for appointment 304a-2 scheduled between consumer C2 and provider P1 may include one or more directions for provider P1 to travel from a starting location associated with previous appointment 304a-1 to the location associated with appointment 304a-2 and consumer C2.

In further embodiments, at least one of travel routes 312 may include an optimized travel route. Optimized travel route may include one or more optimized directions that minimize at least one of a travel time, a travel distance, a fuel consumption and a carbon footprint for the provider. For example, travel route 312a-2 may be an optimized travel route, such that at least one of a travel time, a travel distance, a fuel consumption and a carbon footprint are minimized for provider P1 as provider P1 traverses travel route 312a-2.

Determining complete schedule 310 may also include additional processing blocks, such as generating a visual appealing or graphical complete schedule 310 or indicating potential deficiencies in complete schedule 310 after appointments 304 and 308 have been assessed together. For example, scheduling device 204 may determine a score for complete schedule 308, the score indicating how well complete schedule 310 satisfies certain metrics or minimizes/maximizes certain cost functions or constraints.

It will be appreciated that method 400 allows scheduling device 204 to determine complete schedule 310 and schedule appointments for each of consumers C1-C9 more efficiently or in a more optimized manner than a method that does not include blocks S402-S412. In the exemplary embodiment, at block S404 method 400 determines appointments 306 for a subset of consumers C1-C9. Since this block is performed for each of regions 102 individually, method 400 may be able to satisfy most scheduling constraints in a first pass. As such, partial schedule 306 determined at block S408 may satisfy most scheduling constraints, such as predefined constraints 232a, 232b, 232c. As well, partial schedule 306 includes appointments for each consumer in the subset of consumers C1-C9 with a provider in the same region as the consumer. This may be desirable for providers P1-P3. In a second pass, at block S406 of method 400 appointments 308 may be scheduled for remaining subset of consumers C3, C5, C6 based on partial schedule 306 and the same or different scheduling constraints. Since appointments 308 for remaining subset of consumers C3, C5, C6 may be more difficult to schedule, method 400 reduces the complexity of this scheduling block by only scheduling appointments for remaining subset of consumers C3, C5, C6 instead of all consumers C1-C9. In addition, although at least one of appointments 308 for remaining subset of consumers C3, C5, C6 may be scheduled with a provider in a different region than the consumer, the appointment may still only be scheduled so long as one or more predefined scheduling constraints are still satisfied.

In addition to generating an optimized or near-optimized complete schedule 310 for all consumers C1-C9, method 400 may ensure that complete schedule 310 is determined more efficiently than another complete schedule that is determined using a different method, such as a different method that considers all consumers C1-C9 at once. As such, method 400 may reduce computing power required by computing device 206 to schedule appointments for all consumers C1-C9.

After the completion of method 400, complete schedule 310 may be transmitted by scheduling device 204 to a user or customer using one or more networks 203. For example, complete schedule 310 may be displayed on a user interface, accessible by user or customer through one of client devices 202. Complete schedule 310 may also be shared, for example, with providers P1-P3, such that providers P1-P3 will service customers C1-C9 according to appointments in complete schedule 310. In one embodiment, user interface accessed by a provider, such as provider P1, may only display appointments corresponding to that provider. In a further embodiment, consumers may also receive complete schedule 310, or portions thereof. For example, user interface accessed by a consumer, such as consumer C1, may only display one or more appointments corresponding to that consumer.

In the example of the healthcare industry, healthcare professionals corresponding to providers P1-P3 may receive complete schedule 310. Complete schedule 310 may be accessible to healthcare professionals through user interface, which may be accessible through a hospital or healthcare facility website. In some embodiments, a healthcare professional may only be able to view appointments in complete schedule 310 relevant to that healthcare professional. Similarly, healthcare patients may be able to access complete schedule 310 through user interface, e.g. hospital or healthcare facility website. In some embodiments, a patient may only be able to view appointments in complete schedule 310 relevant to that patient. As well, a hospital or healthcare facility administrator may receive complete schedule 310 through user interface.

In some other embodiments, method 400 may be executed iteratively, such that blocks S402-S410 may be first executed on sub-regions of each of regions 102, and then repeated on regions 102 as described above. In these embodiments, block S410 may additionally include identifying a second remaining subset of consumers that could not be scheduled without violating second predefined constraint.

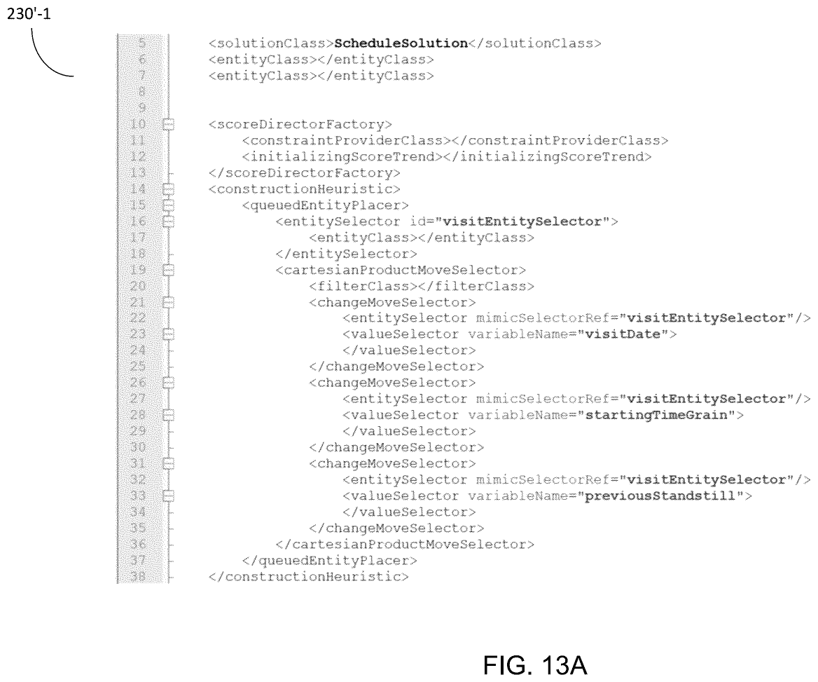

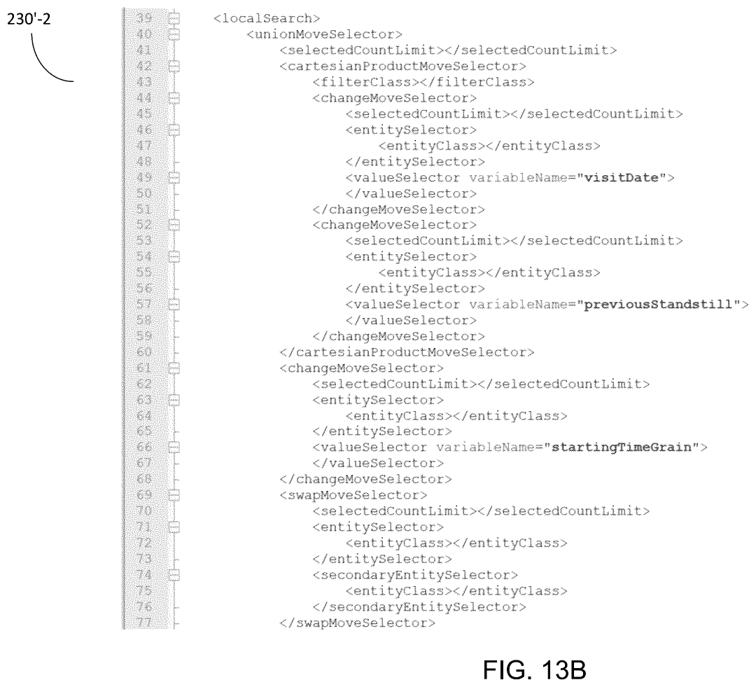

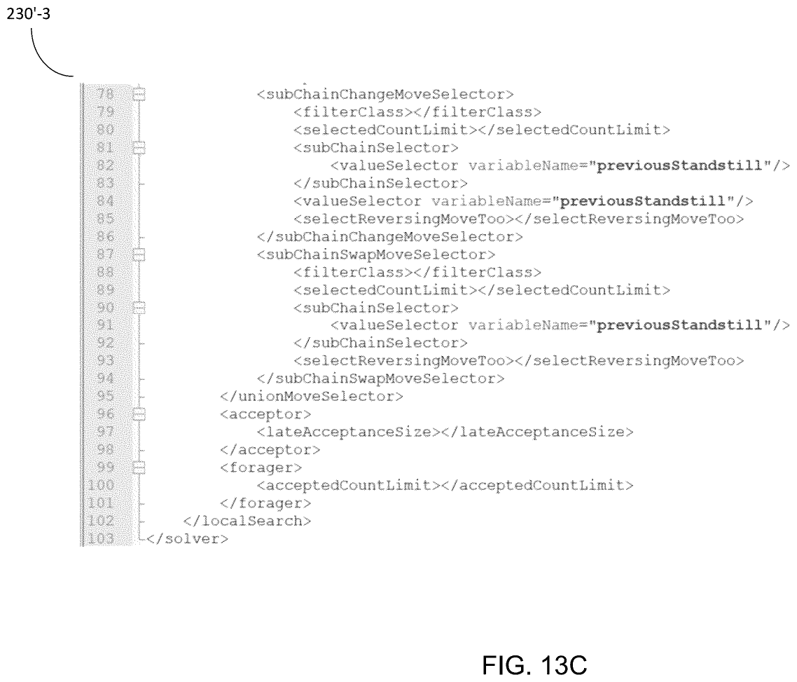

FIGS. 13A-13C depict an alternate embodiment of solution configuration 230′, which may be stored in configuration database 216.

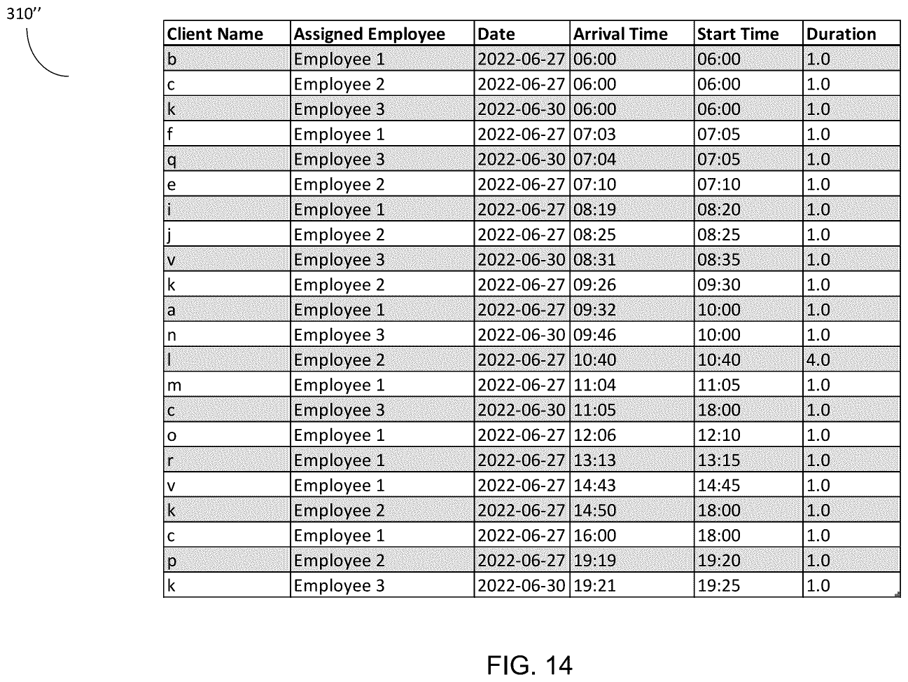

FIG. 14 depicts a further alternate embodiment of complete schedule 310″, which may be generated by scheduling device 204 using method 400.

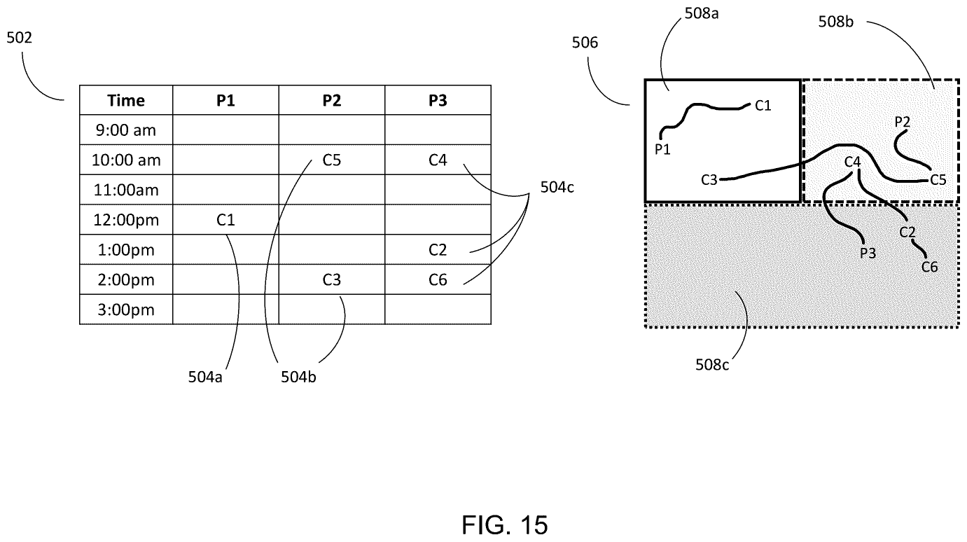

In some other embodiments, scheduling device 204 may also be used to optimize an existing schedule 502, as depicted in FIG. 15. For example, schedule 502 may have been originally generated manually or based on heuristics or conditions, and it may be desirable to optimize schedule 502 using scheduling device 204.

Schedule 502 may already contain existing appointments 504. Scheduling device 204 may be used to optimize appointments 504, such as by rescheduling appointments 504. Rescheduling appointments 504 may include moving a time or location of at least one of appointments 504, assigning a different provider to a consumer associated with at least one of appointments 504, scheduling new appointments for existing or new consumers or providers, or re-generating travel routes 506 associated with appointments 504.

Since schedule 502 may have been already implemented by customer or client, however, it will be appreciated that it may be difficult to re-implement schedule 502 with significant changes. In particular, fully optimizing schedule 502 may cause some appointments to be moved several hours in time, to different locations, or even to include different providers. It may be difficult or impractical for customer or client to absorb these changes. For example, it may be undesirable for a provider to suddenly change their commuting schedule by several hours to accommodate a significantly altered schedule, or for a consumer to suddenly have appointments in the morning instead of the late evening. Thus it may be more desirable to use a sub-optimal or near-optimal schedule 502 which includes only moderate changes that customer or client can easily implement.

A near-optimal schedule may not be fully optimized in the sense of complete schedule 310, generated by method 400. For example, near-optimal schedule may not completely minimize one or more of provider or consumer travel time, travel distance, fuel consumption, and/or carbon footprint. However, near-optimal schedule may be simultaneously optimize one or more of these constraints while simultaneously limiting the changes to schedule 502 to changes that client or customer can comfortably absorb. It will be appreciated that schedule 502 may be near-optimal or sub-optimal in the sense that constraints such as travel time, etc., may only be minimized or maximized to the extent that such changes to existing schedule 502 must be comfortably absorbed by client or customer.

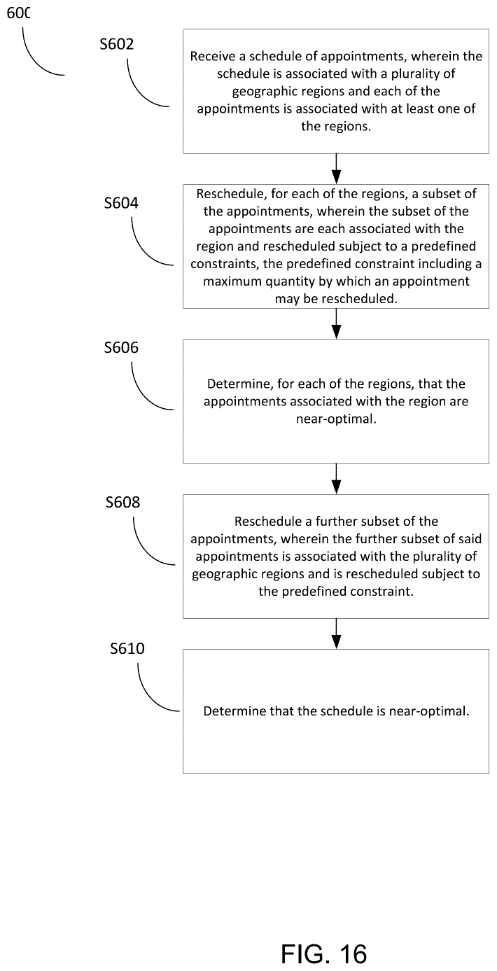

FIG. 16 depicts a method 600 for optimizing existing schedule 502, performed by scheduling device 204. Method 600 may optimize schedule 502 in such a way that customer or client may absorb the changes to schedule 502, even at the expense of a schedule 502 that is sub-optimal or near-optimal. Scheduling device 204 may perform method 600 based on instructions retrieved from configuration database 216.

At block S602, scheduling device 204 receives schedule 502, including appointments 504. Schedule 502 is associated with a plurality of geographic regions 508, and each of appointments 504 is associated with at least one of geographic regions 508. For example, plurality of geographic regions 508 may include geographic regions 508a, 508b, 508c. Some of appointments 504 may be associated with geographic regions 508a, while other of appointments 504 may be associated with geographic regions 508b or 508c.

It will be appreciated that in some situations, one or more appointments 504 may be associated with more than one of geographic regions 508.

Existing schedule 502 may be received by scheduling device 204 from client or customer via a user interface, such as a website or an API, connected to client devices 202. Optionally, portions or all of schedule 502 may be retrieved from resources database 220, since resources database 220 may store resources information received or retrieved from client devices 202.

At block S604, scheduling device 204 reschedules, for each of geographic regions 508, a subset of appointments 504a. For example, scheduling device 204 may reschedule a subset of appointments 504a for geographic region 508a. Subset of appointments 504a are each associated with geographic region 508a.

It will be appreciated that subset of appointments 504a may only include some of appointments 504 associated with geographic region 508a. However, in some situations subset of appointments 504a may include most or all of appointments 504 associated with geographic region 508a. In further embodiments, subset of appointments 504a may also include new appointments between consumers and providers associated with geographic region 508a.

Subset of appointments 504a associated with geographic region 508a may be rescheduled randomly or based on heuristics. It will be understood that various methods for selecting subset of appointments 504a to reschedule are possible and may depend on the optimizer or tool used by scheduling algorithm, as described in detail above.

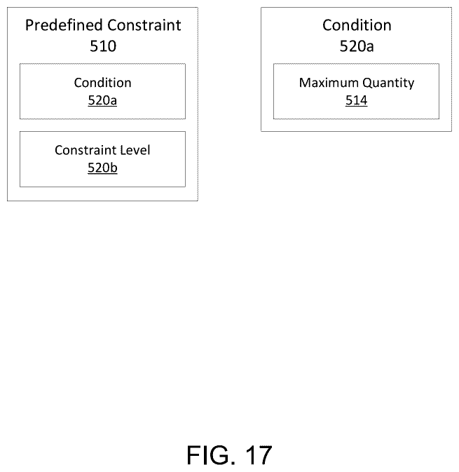

Scheduling device 204 may reschedule subset of appointments 504a subject to predefined constraint 510, as depicted in FIG. 17. Predefined constraint 510 may include a maximum quantity 514 by which a specific time or a specific location of an appointment may be varied. In other words, an appointment may not be rescheduled beyond maximum quantity 514, such that maximum quantity 514 may represent a schedule change threshold beyond which an appointment location or time should not be altered. Maximum quantity 514 may be a quantity of hours between a time of a rescheduled appointment and a time of an original appointment or a distance between a location of a rescheduled appointment and a location of an original appointment. Optionally, maximum quantity 514 may also be a difference between characteristics of a provider associated with a rescheduled appointment versus a provider associated with an original appointment. It will be appreciated that maximum quantity 514 may also include other quantities. As well, maximum quantity 514 may be an array of quantities, such that maximum quantity 514 includes multiple scheduling thresholds for different metrics.

Maximum quantity 514 may be received by scheduling device 204 from client or customer via a user interface, such as a website or an API.

By rescheduling subset of appointments 504a subject to predefined constraint 510, such as subject to maximum quantity 514, scheduling device 204 may help ensure that significant changes are not made to schedule 502. In particular, rescheduling subset of appointments 504a subject to maximum quantity 514 may prevent or at least reduce the probability that schedule 502 includes rescheduled appointments 504 that are beyond what client or customer can comfortably absorb.

For example, client or customer may be unable to accommodate appointments that are rescheduled beyond two hours. As such, maximum quantity 514 may be two hours, such that a rescheduled appointment may not be scheduled at a time two hours before or after that of the original appointment. Alternatively, maximum quantity 514 may be specified as less than or more than two hours, such as one hour, three hours, six hours, etc.

It will be appreciated that maximum quantity 514 may also further include the requirement that appointments not be rescheduled at a different location or with a different provider than the location and provider of the original appointments.

As noted above, predefined constraint 510 must not be violated by any scheduled appointment, and may define objectives that scheduling device 204 may try to achieve while rescheduling appointments. Predefined constraint 510 may include a condition 520a and a constraint level 520b. Condition 520a may describe a rule or objective that should be satisfied to avoid violating predefined constraint 510 and constraint level 520b may describe whether condition 510 may be violated.

Predefined constraint 510 associated with maximum quantity 514 may include a condition 520a incorporating maximum quantity 514. With respect to the example above, condition 520a may require that a rescheduled appointment may not be scheduled at a time 2 hours before or after that of the original appointment. Constraint level 520b may indicate that that predefined constraint 510 is one of a soft, medium or hard constraint level. For example, if constraint level 520b is soft or medium, predefined constraint 510 associated with maximum quantity 514 may allow subset of appointments 504a to be rescheduled to exceed maximum quantity 514, but will penalize the schedule 502.

Scheduling device 204 may penalize schedule 502 using a schedule score 522 for schedule 502 or a region score 524a for appointments 504 associated with geographic region 508a. It will be appreciated that each of regions 508a, 508b, 508c may be associated with a region score 524a, 524b, 524c representing how well each of appointments 504a, 504b, 504c associated with those regions satisfies predefined constraint 510. For example, score 522 may be associated with one or more cost functions used by scheduling device 204. Predefined constraint 510 may be used in cost functions, such that scheduling device 204 may attempt to minimize at least one cost function while rescheduling appointments. Schedule score 522 and/or region scores 524a, 524b, 524c may be determined by weighting the output of one or more cost functions to arrive at a single quantity. If any of subset of appointments 504a, for example, are rescheduled at a time (or some other condition) exceeding maximum quantity 514, a cost function associated with predefined constraint 510 containing maximum quantity 514 may negatively impact schedule score 522 and/or region scores 524a.

Optionally, if constraint level 520b is hard, scheduling device 204 may simply not allow appointments 504 to be rescheduled such that they violate condition 520a associated with maximum quantity 514.

In addition to maximum quantity 514, scheduling device 204 may also reschedule subset of appointments 504a subject to other predefined constraints 504. For example, predefined constraints 504 may specify that a consumer should only be scheduled appointments with a provider located within ten kilometres of consumer, etc. It will be appreciated that a variety of other predefined constraints 504 may be possible.

At block S606, scheduling device 204 determines, for each of geographic regions 508, that appointments 504 associated with each of geographic regions 508 are near-optimal.

For example, after rescheduling subset of appointments 504a, scheduling device 204 may compare region score 524a for appointments 504 associated with geographic region 508a to a previous region score 524a′ for appointments 504 associated with geographic region 508a. In particular, previous region score 524a′ may be the region score for appointments 504 associated with geographic region 508a before rescheduling took place.

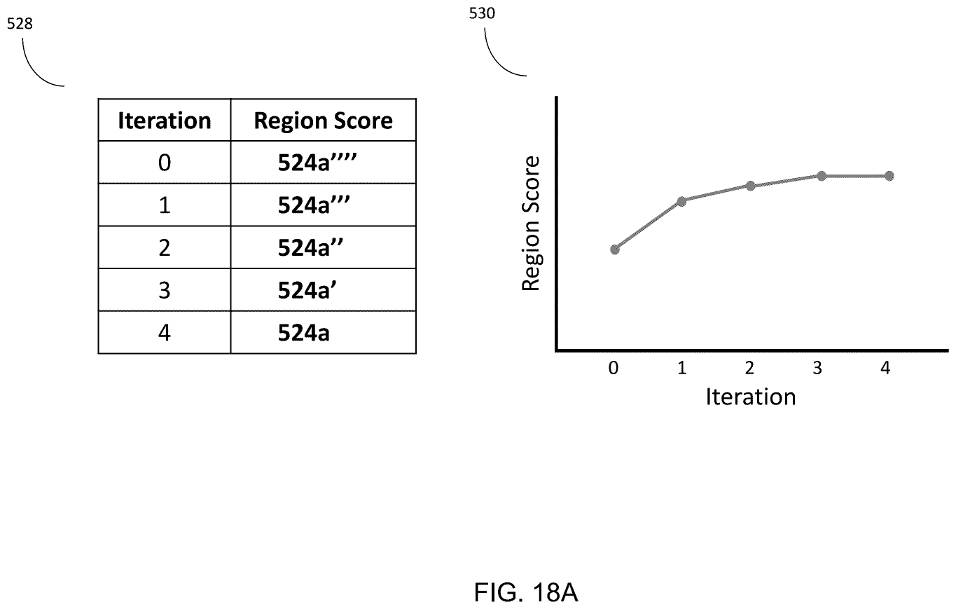

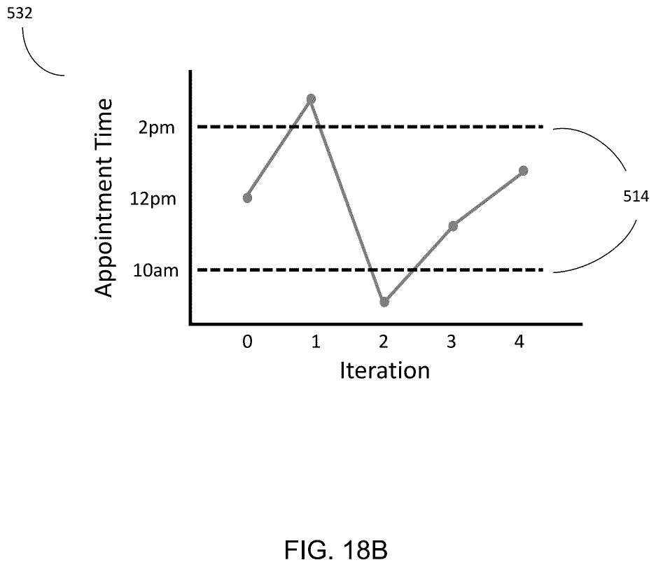

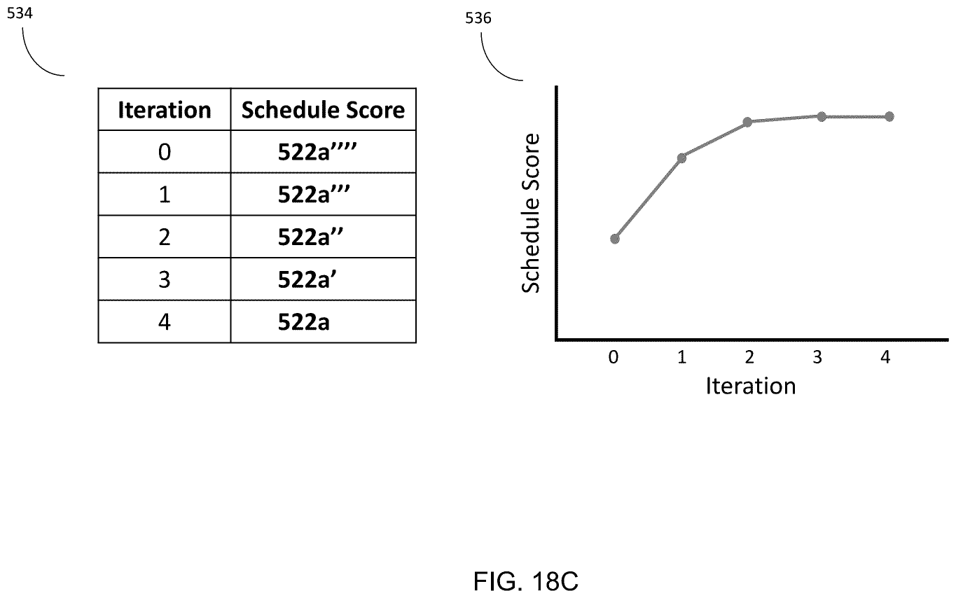

In block S604, scheduling device 204 may also attempt to reschedule subset of appointments 504a iteratively. In particular, blocks S604 and S606 may execute iteratively, as depicted in FIG. 18A. After each iteration, scheduling device 204 may compute a new region score, as depicted in region scores table 528. After four iterations, for example, scheduling device 204 may have computed five region scores, namely region scores 524a, 524a′, 524a″, 524a′″, 524a″″, corresponding to iterations 4, 3, 2, 1 and 0, respectively. Note that region score 524a″″ may represent the zeroth iteration, i.e. the region score for appointments 504 associated with geographic region 508a before rescheduling took place. It will be appreciated that scheduling device 204 may execute fewer or more iterations.

To determine whether, for geographic regions 508a, appointments 504 associated with geographic region 508a are near-optimal, scheduling device 204 may optionally compare all current and previous region scores 524a, 524a′, 524a″, 524a′″, 524a″″ to one another. Scheduling device 204 may assess whether region scores 524a, 524a′, 524a″, 524a′″, 524a″″ have improved as scheduling device 204 has continued to iteratively reschedule appointments 504 associated with geographic region 508a, as depicted in region iteration graph 530. Alternatively, a variety of scheduling algorithms may be used, including a variety of optimization algorithms, as discussed above.

Although optimization algorithms may be used, however, predefined constraint 510, which indicates maximum quantity 514 by which an appointment may be rescheduled, may prevent scheduling device 204 from generating an optimal schedule for appointments 504 associated with geographic region 508a. Instead, maximum quantity 514 may ensure that optimization algorithms reach a near-optimal solution for appointments 504 associated with geographic region 508a while balancing changes to schedule 502 that client or customer can absorb.

FIG. 18B depicts an appointment time graph 532 for one of subset of appointments 504a rescheduled by scheduling device 204 subject to maximum quantity 514. For example, maximum quantity 514 may be +/−2 hours relative to the original time of the appointment in the zeroth iteration, namely 12 pm. As depicted, iterations 1 and 2 exceed maximum quantity 514 for the appointment, while iterations 3 and 4 satisfy maximum quantity 514. Region scores 514′″ and 514″, corresponding to iterations 1 and 2, respectively, may be penalized for exceeding maximum quantity 514, while region scores 514′ and 514, corresponding to iterations 3 and 4, respectively, may not be penalized. Optionally, iterations 1 and 2 may simply result in invalid rescheduled subset of appointments 504a.

It will be understood that blocks S604 and S606 may be executed for each of geographic regions 508, such as geographic regions 508a, 508b, 508c, and the associated appointments 504 for each of those regions. Blocks S604 and S606 for each of geographic regions 508 may execute in parallel, such that blocks S604 and S606 may execute for regions 508a, 508b, 508c at the same time. Alternatively, blocks S604 and S606 for each of geographic regions 508 may execute sequentially, such that blocks S604 and S606 first execute for region 508a, then blocks S604 and S606 again execute for region 508b and blocks S604 and S606 execute again for a final time for region 508c.

In some embodiments, blocks S604 and S606 may execute as a single block, such that scheduling device 204 may assess, for each of geographic regions 508 at once, whether appointments 504 associated with each of geographic regions 508 are near-optimal after each iteration of block S604.

At block S608, scheduling device 204 reschedules a further subset of appointments 504d subject to predefined constraint 510.

Further subset of appointments 504d is associated with geographic regions 508, such that further subset of appointments 504d includes appointments associated with one or more geographic regions 508. For example, further subset of appointments 504d may include appointments 504 associated with each of regions 508a, 508b, 508c. It will be appreciated that block S608 reschedules appointments on a global or schedule-wide scale, such that appointments may be rescheduled between providers and consumers located in different regions, subject to predefined constraint 510.

Block S608 is otherwise similar to block S604, and predefined constraint 510 may also indicate maximum quantity 514 by which an appointment may be rescheduled. As well, scheduling device 204 may execute block S608 iteratively, as depicted in FIG. 18C. Scheduling device 204 may determine schedule score 522 for schedule 502 after each iteration, as depicted in schedule scores table 534.

Block S610 determines that schedule 502 is near optimal. Similar to block S606 discussed above, after rescheduling schedule 502 in block S608, scheduling device 204 may compare schedule score 522 to previous schedule scores 522′, 522″, 522″, 522″″ to determine whether schedule 502 is near optimal, as depicted in schedule iteration graph 536.

Although optimization algorithms may be used in blocks S608 and S610, predefined constraint 510, which indicate maximum quantity 514 by which an appointment may be rescheduled, may prevent scheduling device 204 from generating an optimal schedule 502. Instead, maximum quantity 514 may ensure that optimization algorithms reach a near-optimal solution for schedule 502 while balancing changes to schedule 502 that client or customer can absorb.

In some embodiments, blocks S608 and S610 may execute as a single block, such that scheduling device 204 may assess whether appointments 504 (i.e. schedule 502) are near-optimal after each iteration of block S608.

Although not indicated in FIG. 16, method 600 may further include re-generating travel routes 506 associated with appointments 504. Travel routes 506 may be generated after blocks S602 to S610 have completed, re-generated after each iteration of blocks S604 and/or S608, or after some other block within method 600.

After the completion of method 600, schedule 502 may be transmitted by scheduling device 204 to user or customer using one or more networks 203. For example, schedule 502 may be displayed on a user interface, accessible by user or customer through one of client devices 202. Schedule 502 may also be shared, for example, providers and/or consumers included in schedule 502.

Of course, the above-described embodiments are intended to be illustrative only and in no way limiting. The described embodiments are susceptible to many modifications of form, arrangement of parts, details and order of operation. The invention is intended to encompass all such modification within its scope, as defined by the claims.

What is claimed is:

1. A computer-implemented method for scheduling appointments, wherein each of said appointments is defined by a provider servicing a consumer at a specific time and a specific location, comprising:
identifying geographic regions, each of said regions containing consumers and associated with providers that service said region;
scheduling, for each of said regions, said appointments for a subset of said consumers subject to a first predefined constraint, wherein each of said appointments for said subset of said consumers comprises a provider associated with said region servicing a consumer of said region;
determining a remaining subset of said consumers from each of said regions, wherein said remaining subset of said consumers cannot be scheduled without violating said first predefined constraint;
combining said appointments from each of said regions to determine a partial schedule;
scheduling said appointments for said remaining subset of said consumers subject to a second predefined constraint and said partial schedule, wherein at least one of said appointments for said remaining subset of consumers comprises a provider associated with one of said regions servicing a consumer of another of said regions; and
determining a complete schedule based on said partial schedule and said appointments for said remaining subset of said consumers.

2. The computer-implemented method of claim 1, wherein said partial schedule cannot be modified.

3. The computer-implemented method of claim 1, wherein said partial schedule can be modified to prevent said appointments for said remaining subset of said consumers from violating said second predefined constraint.

4. The computer-implemented method of claim 3, wherein scheduling appointments for said remaining subset of said consumers subject to said second predefined constraint and said partial schedule further comprises:
rescheduling, based on said partial schedule, said appointments for said subset of said consumers subject to said second predefined constraint;
updating said partial schedule with said rescheduled appointments for said subset of said consumers; and
scheduling said appointments for said remaining subset of said consumers subject to said second predefined constraint and said updated partial schedule.

5. The computer-implemented method of claim 3, further comprising receiving, from a user interface, a list of said appointments in said partial schedule that should not be modified.

6. The computer-implemented method of claim 1, wherein said first predefined constraint and said second predefined constraint each comprise a condition and a constraint level, said constraint level indicating whether said condition can be violated.

7. The computer-implemented method of claim 6, wherein said constraint level of said first predefined constraint is higher than said constraint level of said second predefined constraint, such that said condition of said second predefined constraint is more likely to be allowed to be violated while scheduling said appointments than said condition of said first predefined constraint.

8. The computer-implemented method of claim 1, wherein said first predefined constraint and said second predefined constraint are the same.

9. The computer-implemented method of claim 1, wherein determining a complete scheduled based on said partial schedule and said appointments for said remaining subset of said consumers further comprises determining travel routes for each said appointments, each of said travel routes associated with an appointment, said travel route comprising one or more directions for a provider to travel from a starting location to said specific location associated with said appointment.

10. The computer-implemented method of claim 9, wherein said travel routes comprise an optimized travel route, said optimized travel route comprising one or more optimized directions that minimize at least one of a travel time, a travel distance, a fuel consumption and a carbon footprint for said provider.

11. The computer-implemented method of claim 1, wherein scheduling, for each of said regions, said appointments for said subset of said consumers subject to said first predefined constraint further comprises matching a provider to a consumer using at least one cost function.

12. The computer-implemented method of claim 1, further comprising receiving, from a user interface, an indication of said first predefined constraint and determining said first predefined constraint from said indication.

13. The computer-implemented method of claim 12, wherein said at least one of said first predefined constraint comprises at least one of an implementation of union rules and a preference for weekend appointments to be scheduled with junior providers instead of more senior providers.

14. A computer-implemented method for optimizing a schedule of appointments, wherein each of said appointments is defined by a provider servicing a consumer at a specific time and a specific location, comprising:
receiving said schedule of said appointments, wherein said schedule is associated with a plurality of geographic regions and each of said appointments is associated with at least one of said regions;
rescheduling, for each of said regions, a subset of said appointments, wherein said subset of said appointments are each associated with said region and rescheduled subject to a predefined constraint, said predefined constraint comprising a maximum quantity by which at least one of a specific time or a specific location of an appointment may be varied;
determining, for each of said regions, that said appointments associated with said region are near-optimal;
rescheduling a further subset of said appointments, wherein said further subset of said appointments is associated with said plurality of geographic regions and is rescheduled subject to said predefined constraint; and
determining that said schedule is near-optimal.

15. The computer-implemented method of claim 14, further comprising receiving, from a user interface, said maximum quantity by which at least one of a specific time or a specific location of an appointment may be varied.

16. The computer-implemented method of claim 14, wherein said predefined constraints each comprise a condition and a constraint level, said constraint level indicating whether said condition can be violated.

17. The computer-implemented method of claim 14, wherein determining, for each of said regions, that said appointments associated with said region are near-optimal comprises assessing a score for said appointments associated with said region.

18. The computer-implemented method of claim 17, wherein rescheduling an appointment beyond said maximum quantity reduces said score for said appointments associated with said region.

19. The computer-implemented method of claim 17, wherein assessing said score comprises comparing said score to one or more previous scores for said appointments, wherein said previous scores are associated with previous iterations of said appointments associated with said region.

20. The computer-implemented method of claim 14, wherein said maximum quantity is at least one of a quantity of hours between a time of a rescheduled appointment and a time of an original appointment and a distance between a location of said rescheduled appointment and a location of said original appointment.
